(19) United States
(12) Patent Application Publication
(10) Pub. No.: US 2025/0089095 A1
(43) Pub. Date: Mar. 13, 2025

(54) COLLISION REDUCTION FOR RANDOM ACCESS PROCEDURES

(71) Applicant: QUALCOMM Incorporated, San Diego, CA (US)

(72) Inventors: Jing SUN, San Diego, CA (US); Xiaoxia ZHANG, San Diego, CA (US); Jing JIANG, San Diego, CA (US); Raviteja PATCHAVA, San Diego, CA (US)

(21) Appl. No.: 18/466,239

(22) Filed: Sep. 13, 2023

(51) Int. Cl. H04W 74/08; H04W 72/23

(52) U.S. Cl. CPC H04W 74/0833; H04W 72/23

(57) ABSTRACT

Methods, systems, and devices for wireless communication are described. A user equipment (UE) may transmit a random access preamble according to a cyclic shift from a first set of cyclic shifts associated with a cyclic shift step size that is less than a round trip time (RTT) of a serving cell of the UE. The UE may generate the first set of cyclic shifts based on a second set of cyclic shifts and a set of cyclic shift offsets associated with an offset step size that is less than the RTT. If a network entity detects a collision between the random access preamble and another random access preamble, the network entity may transmit a collision resolution message indicating resources for the UE to retransmit the random access preamble. Alternatively, the network entity may proceed with the random access procedure by transmitting a random access response message to the UE.

### FIELD OF TECHNOLOGY

The following relates to wireless communication, including collision reduction for random access procedures.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In wireless communications systems, a UE may establish a connection with a network entity by means of a random access procedure. The UE may transmit, via a physical random access channel (PRACH), a first random access message (e.g., a preamble) to the network entity to initiate the random access procedure. The network entity and the UE may exchange one or more additional random access messages to establish the connection.

### SUMMARY

The described techniques relate to improved methods, systems, devices, and apparatuses that support collision reduction for random access procedures. For example, the described techniques enable a UE to transmit a random access preamble according to a cyclic shift from a first set of cyclic shifts associated with a cyclic shift step size that is less than a round trip time (RTT) (e.g., a maximum RTT) of a cell associated with the UE. The cyclic shift offset may enable a receiving network entity to distinguish between random access preambles communicated by multiple different UEs. In some examples, the UE may generate the first set of cyclic shifts from a second set of cyclic shifts (e.g., nominal cyclic shifts having a second step size greater than or equal to the RTT) and a set of cyclic shift offsets, where the set of cyclic shift offsets is associated with an offset step size (e.g., has a regular or consistent offset step size) that is less than the RTT of a serving cell of the UE. Additionally, or alternatively, the cyclic shift step size of the first set of cyclic shifts may be a consistent (e.g., regular) step size that is less than the RTT.

The network entity associated with the serving cell may receive the random access preamble and may transmit a message to the UE in response to the random access preamble. For example, if the network entity detects a collision between the random access preamble and another random access preamble from a second UE, the network entity may transmit a collision resolution message indicating resources for the UE to retransmit the random access preamble. Alternatively, if the network entity detects no collision, the network entity may proceed with the random access procedure by transmitting a random access response (RAR) message (also referred to as a msg2 or msgB) to the UE.

A method for wireless communication by a UE is described. The method may include receiving a control message indicating a first set of cyclic shifts for transmission of a random access message (e.g., a RACH message) including a random access preamble and transmitting the random access message in accordance with a cyclic shift of the first set of cyclic shifts, the first set of cyclic shifts being associated with a first cyclic shift step size that is less than a RTT associated with a serving cell of the UE.

A UE for wireless communication is described. The UE may include one or more memories storing processor executable code, and one or more processors coupled with the one or more memories. The one or more processors may be individually or collectively operable to execute the code to cause the UE to receive a control message indicating a first set of cyclic shifts for transmission of a random access message including a random access preamble and transmit the random access message in accordance with a cyclic shift of the first set of cyclic shifts, the first set of cyclic shifts being associated with a first cyclic shift step size that is less than a RTT associated with a serving cell of the UE.

Another UE for wireless communication is described. The UE may include means for receiving a control message indicating a first set of cyclic shifts for transmission of a random access message including a random access preamble and means for transmitting the random access message in accordance with a cyclic shift of the first set of cyclic shifts, the first set of cyclic shifts being associated with a first cyclic shift step size that is less than a RTT associated with a serving cell of the UE.

A non-transitory computer-readable medium storing code for wireless communication is described. The code may include instructions executable by a processor to receive a control message indicating a first set of cyclic shifts for transmission of a random access message including a random access preamble and transmit the random access message in accordance with a cyclic shift of the first set of cyclic shifts, the first set of cyclic shifts being associated with a first cyclic shift step size that is less than a RTT associated with a serving cell of the UE.

In some examples of the method, UEs, and non-transitory computer-readable medium described herein, receiving the control message indicating the first set of cyclic shifts may include operations, features, means, or instructions for receiving the control message indicating a second set of cyclic shifts and a set of cyclic shift offsets including the cyclic shift offset, the set of cyclic shift offsets including the first cyclic shift step size and generating the first set of cyclic shifts based on the second set of cyclic shifts and the set of cyclic shift offsets.

Some examples of the method, UEs, and non-transitory computer-readable medium described herein may further include operations, features, means, or instructions for selecting the cyclic shift from the first set of cyclic shifts, the first set of cyclic shifts having a consistent cyclic shift step size that may be less than the RTT.

In some examples of the method, UEs, and non-transitory computer-readable medium described herein, the control message indicates a cyclic shift monitoring range that may be based on the RTT and the method, apparatuses, and non-transitory computer-readable medium may include further operations, features, means, or instructions for receiving a first response message indicating a root of the random access preamble and a second cyclic shift, where the first response message may be for the UE based on the second cyclic shift being spaced from the cyclic shift by less than the cyclic shift monitoring range and transmitting a second response message based on the first response message.

In some examples of the method, UEs, and non-transitory computer-readable medium described herein, the first set of cyclic shifts may be generated based on a second set of cyclic shifts and a set of cyclic shift offsets including the first cyclic shift step size and the second cyclic shift may be of the second set of cyclic shifts.

In some examples of the method, UEs, and non-transitory computer-readable medium described herein, receiving the first response message may include operations, features, means, or instructions for receiving the second random access message indicating a timing advance offset for transmitting the second response message.

In some examples of the method, UEs, and non-transitory computer-readable medium described herein, transmitting the second response message may include operations, features, means, or instructions for transmitting the third random access message based on the timing advance offset and the cyclic shift offset, the timing advance offset being greater than or equal to the cyclic shift offset.

In some examples of the method, UEs, and non-transitory computer-readable medium described herein, the second cyclic shift may be spaced from the cyclic shift based on a propagation delay between the UE and a network entity associated with the serving cell.

In some examples of the method, UEs, and non-transitory computer-readable medium described herein, transmitting the second response message may include operations, features, means, or instructions for transmitting the third random access message based on a timing advance offset, the timing advance offset corresponding to a difference between the second cyclic shift and the cyclic shift, where the third random access message may be transmitted based on the difference being smaller than the cyclic shift monitoring range.

In some examples of the method, UEs, and non-transitory computer-readable medium described herein, transmitting the third random access message may include operations, features, means, or instructions for transmitting the third random access message based on the timing advance offset and the cyclic shift offset, the timing advance offset being greater than or equal to the cyclic shift offset.

In some examples of the method, UEs, and non-transitory computer-readable medium described herein, a size of the cyclic shift monitoring range may be a same size as the first cyclic shift step size of the first set of cyclic shifts.

In some examples of the method, UEs, and non-transitory computer-readable medium described herein, the cyclic shift monitoring range may be greater than or equal to the first cyclic shift step size of the first set of cyclic shifts.

In some examples of the method, UEs, and non-transitory computer-readable medium described herein, receiving the first response message may include operations, features, means, or instructions for receiving the collision resolution message indicating one or more random access channel occasions for transmission of the second response message, where the second response message may be transmitted via a random access channel occasion of the one or more random access channel occasions.

In some examples of the method, UEs, and non-transitory computer-readable medium described herein, the RTT corresponds to a threshold RTT supported by the serving cell.

A method for wireless communication by a network entity is described. The method may include transmitting, to a first UE and a second UE, a control message indicating a first set of cyclic shifts for transmission of one or more random access messages, the first set of cyclic shifts being associated with a first cyclic shift step size that is less than a RTT associated with a serving cell of the network entity, receiving a first random access message of the one or more random access messages from the first UE, the first random access message associated with a first cyclic shift based on the first set of cyclic shifts, receiving a second random access message of the one or more random access messages from the second UE, the second random access message associated with a second cyclic shift based on the first set of cyclic shifts, and transmitting a response message for the first UE based on the control message, the first cyclic shift, and the second cyclic shift.

A network entity for wireless communication is described. The network entity may include one or more memories storing processor executable code, and one or more processors coupled with the one or more memories. The one or more processors may be individually or collectively operable to execute the code to cause the network entity to transmit, to a first UE and a second UE, a control message indicating a first set of cyclic shifts for transmission of one or more random access messages, the first set of cyclic shifts being associated with a first cyclic shift step size that is less than a RTT associated with a serving cell of the network entity, receive a first random access message of the one or more random access messages from the first UE, the first random access message associated with a first cyclic shift based on the first set of cyclic shifts, receive a second random access message of the one or more random access messages from the second UE, the second random access message associated with a second cyclic shift based on the first set of cyclic shifts, and transmit a response message for the first UE based on the control message, the first cyclic shift, and the second cyclic shift.

Another network entity for wireless communication is described. The network entity may include means for transmitting, to a first UE and a second UE, a control message indicating a first set of cyclic shifts for transmission of one or more random access messages, the first set of cyclic shifts being associated with a first cyclic shift step size that is less than a RTT associated with a serving cell of the network entity, means for receiving a first random access message of the one or more random access messages from the first UE, the first random access message associated with a first cyclic shift based on the first set of cyclic shifts, means for receiving a second random access message of the one or more random access messages from the second UE, the second random access message associated with a second cyclic shift based on the first set of cyclic shifts, and means for transmitting a response message for the first UE based on the control message, the first cyclic shift, and the second cyclic shift.

A non-transitory computer-readable medium storing code for wireless communication is described. The code may include instructions executable by a processor to transmit, to a first UE and a second UE, a control message indicating a first set of cyclic shifts for transmission of one or more random access messages, the first set of cyclic shifts being associated with a first cyclic shift step size that is less than a RTT associated with a serving cell of the network entity, receive a first random access message of the one or more random access messages from the first UE, the first random access message associated with a first cyclic shift based on the first set of cyclic shifts, receive a second random access message of the one or more random access messages from the second UE, the second random access message associated with a second cyclic shift based on the first set of cyclic shifts, and transmit a response message for the first UE based on the control message, the first cyclic shift, and the second cyclic shift.

In some examples of the method, network entities, and non-transitory computer-readable medium described herein, transmitting the response message may include operations, features, means, or instructions for determining that the first random access message and the second random access message may be separable in a cyclic shift domain and transmitting the random access response message including a timing advance offset and an indication of a third cyclic shift based on the first cyclic shift.

In some examples of the method, network entities, and non-transitory computer-readable medium described herein, transmitting the control message may include operations, features, means, or instructions for transmitting the control message indicating a cyclic shift monitoring range, the random access response message being for the first UE based on the third cyclic shift being within the cyclic shift monitoring range from the first cyclic shift.

In some examples of the method, network entities, and non-transitory computer-readable medium described herein, the first set of cyclic shifts may be generated based on a second set of cyclic shifts and a set of cyclic shift offsets including the first cyclic shift step size and the third cyclic shift may be of the second set of cyclic shifts.

Some examples of the method, network entities, and non-transitory computer-readable medium described herein may further include operations, features, means, or instructions for computing the timing advance offset based on the third cyclic shift.

In some examples of the method, network entities, and non-transitory computer-readable medium described herein, the third cyclic shift may be the same as the first cyclic shift.

In some examples of the method, network entities, and non-transitory computer-readable medium described herein, the random access response message includes a medium access control control element (MAC-CE).

In some examples of the method, network entities, and non-transitory computer-readable medium described herein, transmitting the response message may include operations, features, means, or instructions for determining that the first cyclic shift may be the same as the second cyclic shift and that the first random access message was received at a same time as the second random access message and transmitting the collision resolution message for the first UE based on the control message and the determining, the collision resolution message including an indication of a third cyclic shift that may be based on the first cyclic shift.

In some examples of the method, network entities, and non-transitory computer-readable medium described herein, the first set of cyclic shifts may be generated based on a second set of cyclic shifts and a set of cyclic shift offsets including the first cyclic shift step size and the third cyclic shift may be of the second set of cyclic shifts.

In some examples of the method, network entities, and non-transitory computer-readable medium described herein, the third cyclic shift may be the same as the first cyclic shift.

In some examples of the method, network entities, and non-transitory computer-readable medium described herein, transmitting the collision resolution message may include operations, features, means, or instructions for transmitting the collision resolution message indicating one or more random access channel occasions for the first UE to transmit a second response message.

In some examples of the method, network entities, and non-transitory computer-readable medium described herein, transmitting the control message may include operations, features, means, or instructions for transmitting the control message indicating a cyclic shift monitoring range, the response message being for the first UE based on the third cyclic shift and the monitoring range.

In some examples of the method, network entities, and non-transitory computer-readable medium described herein, transmitting the response message may include operations, features, means, or instructions for transmitting the response message based on a comparison between the first random access message and the second random access message based on previous collision information associated with the serving cell, multipath information associated with the serving cell, or a combination thereof.

In some examples of the method, network entities, and non-transitory computer-readable medium described herein, the RTT may be a maximum RTT of the serving cell.

### BRIEF DESCRIPTION OF THE DRAWINGS

FIG. 1 shows an example of a wireless communications system that supports collision reduction for random access procedures in accordance with one or more aspects of the present disclosure.

FIG. 2 shows an example of a wireless communications system that supports collision reduction for random access procedures in accordance with one or more aspects of the present disclosure.

FIGS. 3A and 3B show examples of cyclic shift diagrams that support collision reduction for random access procedures in accordance with one or more aspects of the present disclosure.

FIGS. 4A and 4B show examples of cyclic shift diagrams that support collision reduction for random access procedures in accordance with one or more aspects of the present disclosure.

FIG. 5 shows an example of a process flow that supports collision reduction for random access procedures in accordance with one or more aspects of the present disclosure.

FIGS. 6 and 7 show block diagrams of devices that support collision reduction for random access procedures in accordance with one or more aspects of the present disclosure.

FIG. 8 shows a block diagram of a communications manager that supports collision reduction for random access procedures in accordance with one or more aspects of the present disclosure.

FIG. 9 shows a diagram of a system including a device that supports collision reduction for random access procedures in accordance with one or more aspects of the present disclosure.

FIGS. 10 and 11 show block diagrams of devices that support collision reduction for random access procedures in accordance with one or more aspects of the present disclosure.

FIG. 12 shows a block diagram of a communications manager that supports collision reduction for random access procedures in accordance with one or more aspects of the present disclosure.

FIG. 13 shows a diagram of a system including a device that supports collision reduction for random access procedures in accordance with one or more aspects of the present disclosure.

FIGS. 14 through 19 show flowcharts illustrating methods that support collision reduction for random access procedures in accordance with one or more aspects of the present disclosure.

### DETAILED DESCRIPTION

In wireless communication networks, a connection between a network entity and a user equipment (UE) in a cell may be achieved using a random access procedure. To initiate the random access procedure, the UE may send a physical random access channel (PRACH) preamble in a first transmission (e.g., a first random access message) to the network entity. The preamble may include or be an example of a preamble sequence, which may also be referred to herein as a PRACH sequence, a root sequence, or the like. To generate the preamble, the UE may select a preamble sequence from a set of preamble sequences configured for random access procedures. The UE may generate the preamble based on the selected preamble sequence and a selected cyclic shift from a set of cyclic shifts. The set of preamble sequences and the set of cyclic shifts may provide distinction between preambles sent from multiple UEs, as each UE transmitting a preamble may select a different preamble sequence and cyclic shift. That is, the network entity may detect that received preambles originated from different UEs based on each preamble being associated with a different preamble sequence. Additionally, or alternatively, each preamble may have a different arrival time at the network entity based on the corresponding cyclic shift. Thus, even if two UEs select a same preamble sequence, the network entity may detect that the received preambles originated from different UEs based on each preamble having a different arrival time at the network entity.

In some examples, the set of preamble sequences may be assigned on a per-cell or per-network entity basis. Thus, a set of preamble sequences should include a sufficient quantity of preamble sequences such that it is unlikely that two UEs in a cell select a same preamble sequence at a same or similar time. Additionally, a set of cyclic shifts may be associated with a cyclic shift step size (e.g., a spacing between each cyclic shift in the set of cyclic shifts) that prevents overlap in cyclic shifts detected by the network entity, for example, based on a size of the cell and a corresponding propagation delay. In some scenarios, however, such as in large cells with many UEs, there is still a chance of contention, e.g., of two or more different UEs initiating a random access procedure by transmitting the same preamble sequence at the same or similar time. For instance, the quantity of preamble sequences may be limited and may not be sufficient for the cell. As another example, in smaller cells, if two UEs select a same cyclic shift for respective preambles, the corresponding propagation delay may not be sufficient to provide a distinction between the arrival times of preambles received at the network entity.

In such scenarios, the network entity may be unable to distinguish between the two UEs. For example, when multiple preambles have a same or similar arrival time at the network entity—particularly if the preambles are associated with a same preamble sequence or cyclic shift—the network entity may be unable to detect that separate preambles have been received, such that the random access procedure may be successful for one of the UEs. The other UE will have to reinitiate the random access procedure, thereby wasting resources and increasing the time delay for the other UE to establish the connection with the network entity. Moreover, when the quantity of preamble sequences is limited, the likelihood that multiple UEs select a same preamble sequence may increase as the quantity of UEs in the cell increases.

Accordingly, the techniques described herein support cyclic shifts for transmission of preambles in random access procedures, which may enable the network entity to separate received preambles even when the preambles have a same or similar arrival time at the network entity. For example, a UE may transmit a random access preamble according to a cyclic shift from a first set of cyclic shifts associated with a cyclic shift step size that is less than a round trip time (RTT) (e.g., a maximum RTT) of a cell associated with the UE. In some examples, the UE may generate the first set of cyclic shifts from a second set of cyclic shifts (e.g., nominal cyclic shifts having a second step size greater than or equal to the RTT) and a set of cyclic shift offsets, where the set of cyclic shift offsets is associated with an offset step size (e.g., has a regular or consistent offset step size) that is less than the RTT of a serving cell of the UE. The cyclic shift offset may enable a receiving network entity to distinguish between random access preambles communicated by multiple different UEs, e.g., even if two (or more) UEs select a same cyclic shift. Additionally, or alternatively, the cyclic shift step size of the first set of cyclic shifts may be a consistent (e.g., regular) step size that is less than the RTT, which may provide a greater number of cyclic shifts for the first set of cyclic shifts, e.g., compared to a set of cyclic shifts having a step size that is greater than or equal to the RTT. As such, the likelihood that the network entity is unable to distinguish between received preambles may be decreased without increasing the quantity of preamble sequences available in the set of preamble sequences. That is, the chance that two or more different UEs generate respective preambles based on a same preamble sequence and cyclic shifts described herein (e.g., compared to preambles generated based on only a preamble sequence and a traditional cyclic shift) is decreased. Based on differentiating between received preambles, the network entity may transmit a respective random access response (RAR) message to each transmitting UE (e.g., each UE that transmitted a preamble) to continue the random access procedure.

The techniques described herein also support resolution of preamble collisions at the network entity. For example, if the network entity detects that a collision between preambles has occurred, e.g., if the network entity is unable to identify a respective originating UE for each preamble, the network entity may transmit one or more collision resolution messages. The one or more collision resolution messages may indicate one or more pairs of cyclic shifts and preamble sequences detected by the network entity and one or more random access occasions (ROs) for a subsequent UE transmission. A UE may receive a collision resolution message and, if an indicated cyclic shift/preamble sequence pair matches the cyclic shift and preamble sequence used by the UE to generate the preamble, the UE may retransmit the preamble to the network entity via an indicated RO. By designating ROs for the preamble retransmission, the network entity may prevent further preamble collisions, thereby enabling the UE to proceed with the random access procedure without additional delay.

Aspects of the disclosure are initially described in the context of wireless communications systems. Aspects of the disclosure are then discussed with reference to cyclic shift diagrams and a process flow. Aspects of the disclosure are further illustrated by and described with reference to apparatus diagrams, system diagrams, and flowcharts that relate to collision reduction for random access procedures.

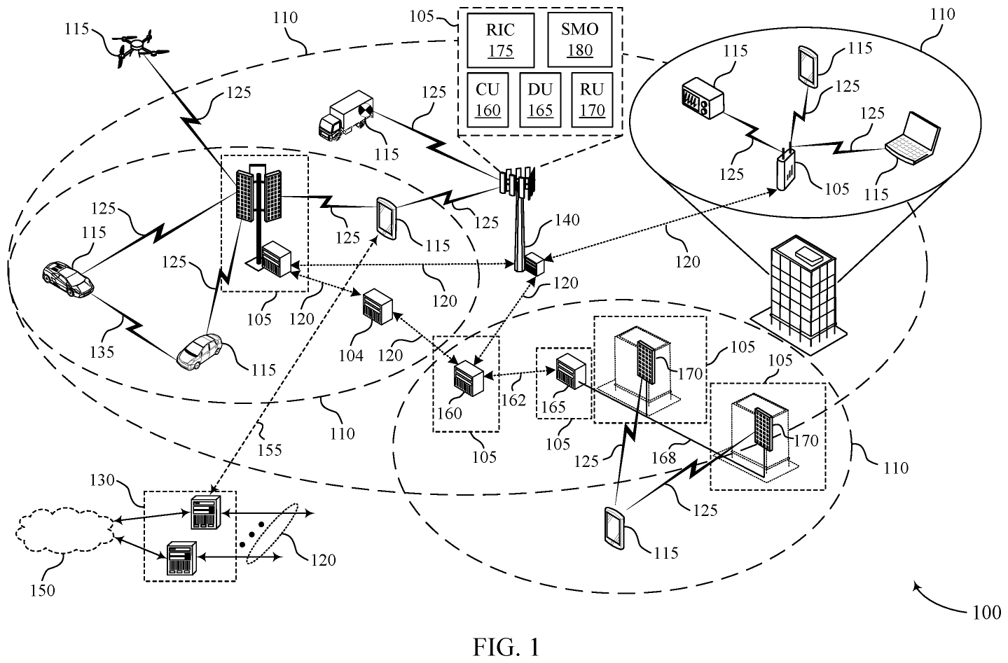

FIG. 1 shows an example of a wireless communications system 100 that supports collision reduction for random access procedures in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (cNB), a next-generation NodeB or a giga-NodeB (either of which may be referred to as a gNB), a 5G NB, a next-generation eNB (ng-cNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support collision reduction for random access procedures as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In the wireless communication system 100, a network entity 105 and a UE 115 may perform a connection procedure (such as an RRC procedure, a cell acquisition procedure, a random access procedure, an RRC connection procedure, an RRC configuration procedure). For example, a network entity 105 and a UE 115 may perform a random access procedure (e.g., a RACH procedure, a PRACH procedure) to establish an initial connection with one another. In some other examples, a network entity 105 and a UE 115 may perform a random access procedure to re-establish a connection after a connection failure (such as a radio link failure), or to establish a connection for handover to another network entity 105, or the like.

To initiate the random access procedure, a UE 115 may transmit, via a random access channel (e.g., RACH, PRACH) a first message (e.g., Msg1) that includes a random access preamble (also referred to as a RACH preamble, a PRACH preamble, a sequence, a preamble sequence, a PRACH sequence or the like). Some implementations of a random access procedure may be contention-based (e.g., contention-based random access (CBRA)) or contention-free (e.g., contention-free random access (CFRA)). When performing a CBRA procedure, such as a 4-step random access procedure, the UE 115 (and any other UEs 115 attempting random access with the network entity 105) may randomly select a preamble sequence from a set of preamble sequences (e.g., 64 preamble sequences) and, in some cases, a cyclic shift from a set of cyclic shifts. The UE 115 may generate the random access preamble using the selected preamble sequence and the selected cyclic shift.

Upon receiving a random access preamble, the network entity 105 may estimate a transmission timing of the UE 115. Based on the estimated transmission timing, the network entity 105 may calculate or otherwise determine a timing advance (TA) for the UE 115. The network entity 105 may transmit a second message (e.g., Msg2, RAR) to the UE 115 to indicate the TA and one or more uplink resources (e.g., time resources, frequency resources). The UE 115 may transmit, via the one or more uplink resources and according to the TA, a third message (e.g., Msg3) in the random access procedure. Based on receiving the third message, the network entity 105 may transmit a fourth message (e.g., Msg4) to the UE 115 to complete the random access procedure.

The preamble sequence may be an example of a Zadoff-Chu sequence, and the cyclic shift may be understood as a time-domain shift (e.g., delay) of the preamble sequence. Each cyclic shift may be separated from other cyclic shifts in the set of cyclic shifts by a cyclic shift step size, which may be based on a round trip time (RTT) (e.g., a propagation time, also referred to as a propagation delay) of a serving cell associated with the network entity 105. As long as the cyclic shift step size is greater than the maximum RTT of the serving cell (and, in some cases, a maximum delay spread of the random access channel), the cross-correlation between different preambles that are based on cyclic shifts of a same preamble sequence may be zero at the network entity 105. Thus, the network entity 105 may identify an originating UE 115 (e.g., a source UE 115 from which the preamble was transmitted) for a received preamble based on the corresponding preamble sequence and cyclic shift. Specifically, the network entity 105 may process the preamble to detect or otherwise determine the preamble sequence and cyclic shift with which the preamble was generated. The cyclic shift detected at the network entity 105 may be based on the RTT of the serving cell. That is, the network entity 105 may detect which nominal cyclic shift was used to generate the preamble based on the detected cyclic shift and a propagation delay associated with the preamble.

However, in some cases, the network entity 105 may be unable to differentiate between multiple received preambles or transmitting UEs 115. For example, if two (or more) UEs 115 inadvertently select a same preamble sequence and a same cyclic shift to transmit respective preambles, and if-after corresponding propagation delays-both preambles arrive at the network entity 105 at a same or similar arrival time, the preambles may be indistinguishable in the time domain, which may be referred to as a time domain collision. Put another way, the two preambles may appear to the network entity 105 as a single signal. In another example, the network entity 105 may incorrectly detect cyclic shifts for each preamble. For instance, the cyclic shift step size may be suboptimal such that multiple nominal cyclic shifts may correspond to a single detected cyclic shift, or the detected cyclic shift for multiple preambles may appear to be the same after accounting for respective propagation delays.

The quantity of preamble sequences available for a network entity 105 or a serving cell may be limited, and the quantity of cyclic shifts available for the network entity 105 or the serving cell may be based on a size of the serving cell. Thus, as the number of UEs 115 served by the network entity 105 increases, the likelihood that multiple UEs 115 select a same preamble sequence, a same cyclic shift, or both, may also increase, thereby increasing the likelihood of collisions between preambles.

According to the techniques described herein, the wireless communications system 100 may support the use of cyclic shifts for random access procedures where the cyclic shifts are from a first set of cyclic shifts associated with a cyclic shift step size that is less than an RTT of a serving cell of a UE 115, which may effectively increase the quantity of cyclic shifts, thereby enabling the network entity 105 to distinguish between received preambles without increasing the quantity of preamble sequences or the quantity of cyclic shifts.

For example, the UE 115 may generate the first set of cyclic shifts based on a second set of cyclic shifts (e.g., a set of nominal cyclic shifts, a set of cyclic shifts with a spacing that is greater than or equal to the RTT) and a set of cyclic shift offsets, where the set of cyclic shift offsets may have an offset spacing (e.g., a consistent offset spacing, which may also be referred to herein as an offset step size, a cyclic shift offset step size, or the like) that is less that the RTT. That is, the first set of cyclic shifts may be effectively equivalent to a combination of the second set of cyclic shifts with the set of cyclic shift offsets. The cyclic shift offset may be defined as an offset from a cyclic shift of the second set of cyclic shifts, and cyclic shifts of the second set of cyclic shifts may be referred to as nominal cyclic shifts. The UE 115 may transmit the preamble according to a cyclic shift from the first set of cyclic shifts, e.g., according to the combination of a nominal cyclic shift (e.g., from the second set of cyclic shifts) and a cyclic shift offset. As such, even if another UE 115 selects a same preamble sequence or nominal cyclic shift, the cyclic shift offset may differentiate the preamble from other preambles at the network entity 105.

As another example of the first set of cyclic shifts, the cyclic shift spacing associated with the first set of cyclic shifts may be a consistent (e.g., regular) spacing that is less than the RTT. In such examples, the UE 115 may transmit the preamble according to a cyclic shift selected from effectively more cyclic shifts than may be available otherwise. As such, even if another UE 115 selects a same preamble sequence, the increase in quantity of cyclic shifts may decrease the chance of the other UE 115 selecting the same cyclic shift, increasing the chances that the network entity 105 is able to differentiate the preamble from other preambles.

Based on receiving the preamble, the network entity 105 may transmit a random access response (RAR) message to the UE 115 to continue the random access procedure. For example, if the preamble from the UE 115 does not collide (e.g., in time and cyclic shift domains) with another preamble, the network entity 105 may transmit a second RACH message to the UE 115, continuing the random access procedure.

However, if the network entity 105 detects that a collision between preambles has occurred, e.g., if the network entity 105 is unable to identify a respective originating UE 115 for each received preamble, the network entity 105 may transmit one or more collision resolution messages, which may also be referred to herein as a msgX. The one or more collision resolution messages may indicate one or more pairs of cyclic shifts and preamble sequences detected by the network entity and one or more ROs for a subsequent UE transmission. A UE 115 may receive a collision resolution message and, if an indicated cyclic shift/preamble sequence pair matches the cyclic shift and preamble sequence used by the UE 115 to generate the preamble, the UE 115 may transmit a msgY, which may be defined as a collision resolution response message (e.g., a response message to the collision resolution message). In some cases, the msgY may include one or more reference signals. Additionally, or alternatively, the UE 115 may retransmit the preamble to the network entity 105 within the msgY and via an RO indicated in the collision resolution message. In yet another example, the UE 115 may select (e.g., reselect) a different preamble sequence, a different cyclic shift, or a combination thereof, to use for generating the msgY. The network entity 105 may receive the msgY via the indicated RO, which may avoid collisions with other preambles from other UEs 115. In response to the msgY, the network entity 105 may transmit a RAR message (e.g., msg2) to the UE 115 to continue the random access procedure.

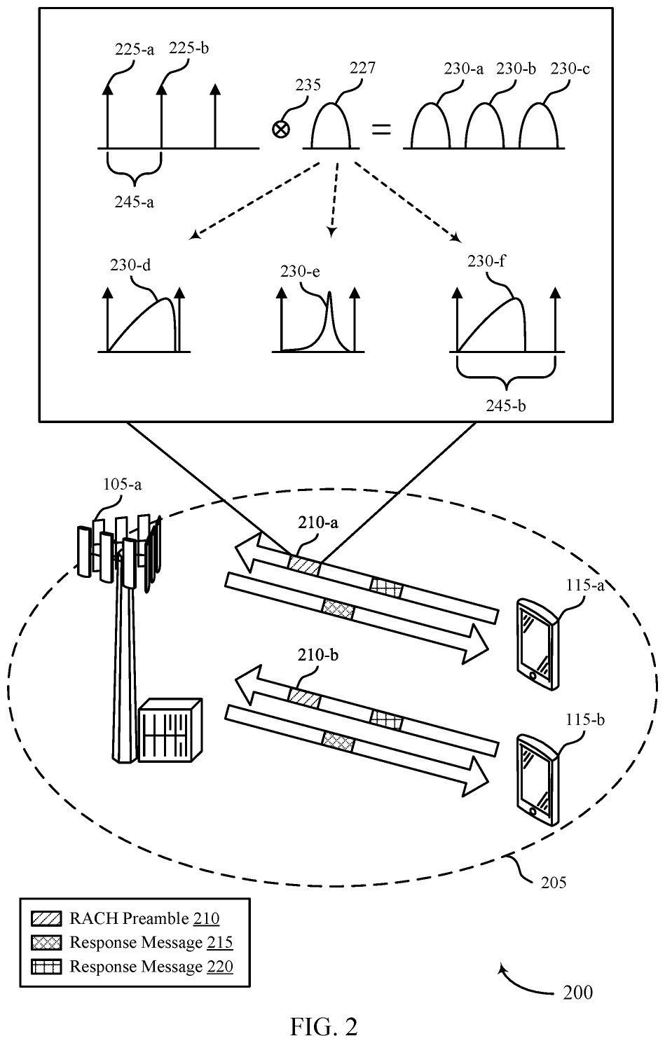

FIG. 2 shows an example of a wireless communications system 200 that supports collision reduction for random access procedures in accordance with one or more aspects of the present disclosure. The wireless communications system 200 may implement or be implemented by aspects of the wireless communication system 100. For example, the wireless communications system 200 may include a network entity 105-a and UEs 115 (e.g., a UE 115-a and a UE 115-b), which may be examples of the corresponding devices as described with reference to FIG. 1. In some cases, the network entity 105-a may be an example of one or more transmission reception points (TRPs). Although quantities of network entities 105 and UEs 115 are shown in FIG. 2, it is noted that the aspects and techniques of the present disclosure may be applied to any quantity of network entities 105, UEs 115, or both.

In the wireless communications system 200, the network entity 105-a may serve a cell 205 in which the UE 115-a and the UE 115-b may operate. To establish an initial link with the network entity 105-a, each UE 115 may initiate a random access (RACH) procedure. For example, the UE 115-a and the UE 115-b may each transmit a respective RACH preamble 210 (e.g., a RACH preamble 210-a and a RACH preamble 210-b, respectively), which may be referred to as msg1, to the network entity 105-a. In response to receiving the RACH preamble 210-a and the RACH preamble 210-b, the network entity 105-a may transmit one or more first response messages 215 (e.g., msg2 or msgX) to the UE 115-a and the UE 115-b, respectively. In response to the first response messages 215, the UE 115-a and the UE 115-b may transmit one or more second response messages 220 to the network entity 105-a (e.g., msg3 or msgY).

The UE 115-a and the UE 115-b may generate the RACH preamble 210-a and the RACH preamble 210-b, respectively. For example, the UE 115-a and the UE 115-b may each select (e.g., randomly select) a preamble sequence (e.g., a root) from a set of preamble sequences. Additionally, the UE 115-a and the UE 115-b may each select (e.g., randomly select) a cyclic shift 225 from one or more cyclic shifts 225. In some cases, the one or more cyclic shifts 225 may be associated with a set of cyclic shifts configured for the cell 205, the network entity 105-a, or both. In some examples, the network entity 105-a may transmit a control message indicating the set of cyclic shifts (e.g., a first set of cyclic shifts, a second set of cyclic shifts, or a combination thereof), the set of preamble sequences, or both, to the UEs 115.

To generate a RACH preamble 210, a UE 115 may apply the selected cyclic shift 225 to the selected preamble sequence. The cyclic shift 225 may shift the preamble sequence in a frequency domain, which may result in a time-domain shift (e.g., delay) from the perspective of the network entity 105-a (e.g., after the network entity 105-a performs a Fourier transform on the received RACH preamble 210). For example, the cyclic shift 225 may shift the preamble sequence by a fixed amount (e.g., by a cyclic shift step size 245), which may allow a first preamble sequence with a first cyclic shift 225 to be orthogonal to (e.g., to avoid interference or collisions with) a second preamble sequence (e.g., with the same root as the first preamble sequence) with a second cyclic shift 225.

Each RACH preamble 210 may be associated with a respective arrival time at the network entity 105-a, where the arrival time may be based on the corresponding cyclic shift 225 (e.g., because the cyclic shift 225 translates to a delay in the time domain). An arrival time of a RACH preamble 210 may be further based on a time taken by the RACH preamble 210 to travel from the corresponding UE 115 to the network entity 105-a, which may be referred to as a propagation delay (e.g., half of an RTT).

For each RACH preamble 210 received at the network entity 105-a, the network entity 105-a may detect or otherwise determine a corresponding preamble sequence and cyclic shift 225 used to generate the RACH preamble 210, which may, in turn, identify which UE 115 transmitted the RACH preamble 210. The cyclic shift 225 determined by the network entity 105-a may be referred to herein as a detected cyclic shift, while the cyclic shift 225 selected by the UE 115 to generate the RACH preamble 210 may be referred to herein as a nominal cyclic shift. The network entity 105-a may process the RACH preamble 210 to determine the detected cyclic shift. After accounting for the corresponding propagation delay, the network entity 105-a may identify the nominal cyclic shift based on the detected cyclic shift. For example, the network entity 105-a may determine which cyclic shift 225 of the set of cyclic shifts is closest to the detected cyclic shift, and may select that cyclic shift 225 as the nominal cyclic shift.

To continue the RACH procedure initiated by the RACH preamble 210, the network entity 105-a may transmit a RAR message (e.g., msg2) to the corresponding UE 115 that indicates the preamble sequence and cyclic shift 225 (e.g., the nominal cyclic shift) determined by the network entity 105-a. The UE 115 may monitor for a RAR message that includes the preamble sequence and cyclic shift 225 that the UE 115 used to generate the RACH preamble 210. In this manner, the preamble sequence and cyclic shift 225 associated with a RACH preamble 210 may be used as device identifiers and may enable the network entity 105-a to distinguish between RACH preambles 210 received from different UEs 115 in the cell 205.

In some examples, however, a collision between RACH preambles 210 (e.g., the RACH preamble 210-a and the RACH preamble 210-b) may occur if both RACH preambles 210 are associated with a same cyclic shift 225, a same preamble sequence (e.g., a same root), and a same or similar arrival time at the network entity 105-a. In such examples, the RACH preamble 210-a and the RACH preamble 210-b may appear to the network entity 105-a as a same RACH preamble 210. That is, the network entity 105-a may be unable to determine which UE 115 transmitted each RACH preamble 210 or may not be aware that two RACH preambles 210 have been received. Thus, the network entity 105-a may be unable to accurately receive both RACH preambles 210, or may assume that only a single RACH preamble 210 has been received.

In such examples, the network entity 105-a may trigger additional messaging for contention resolution due to such collisions. For example, the network entity 105-a may detect that the RACH preamble 210-a and the RACH preamble 210-b experienced a collision (e.g., the network entity may detect that a RACH preamble 210 has been transmitted from more than one UE 115, but may be unable to correctly receive and decode the information in each RACH preamble 210), and may transmit one or more response messages 215 to the UEs 115. A response message 215 may include or be an example of a collision resolution message, which may also be referred to herein as a msgX, and may signal for the UEs 115 to transmit one or more response messages 220 to the network entity 105-a. The response message 215 may include, for example, which UE 115 each response message 215 may be addressed to and one or more resources for the UE 115 to use to transmit a response message 220. That is, each response message 215 may indicate one or more parameters for a corresponding response message 220 to be transmitted by the corresponding UE 115. The corresponding UE 115 may determine that the response message 215 is intended for the UE 115 based on the preamble sequence and cyclic shift 225 indicated in the response message 215 (e.g., if the indicated preamble sequence and cyclic shift 225 match those used by the UE 115 to generate the corresponding RACH preamble 210) and may transmit the response message 220 via the indicated resources (e.g., with the indicated cyclic shift or with a randomly selected cyclic shift).

More specifically, the response message 215 may indicate one or more pairs of a cyclic shift 225 and a preamble sequence associated with (e.g., detected from) the received RACH preambles 210. Additionally, or alternatively, the response message 215 may indicate resources (e.g., one or more ROs) for a UE 115 to transmit a response message 220. The multiple ROs may allow for more resources to reduce a likelihood of collisions between response messages 220 transmitted by different UEs 115. For example, the response message 215 may indicate (e.g., via a bitmap of ROs, a quantity of ROs, or the like) one or more frequency domain resources, one or more time domain resources, a time domain offset (e.g., in slots or symbols) from reception of the response message 215, or some combination thereof. In some examples, the response message 215 may further indicate a cyclic shift step size 245, which may be different from the cyclic shift step size 245 used to generate the RACH preambles 210.

A UE 115 receiving a collision resolution message (e.g., a response message 215) may determine that the collision resolution message is addressed to the UE 115 if the preamble sequence and cyclic shift 225 indicated in the collision resolution message are the same as those used by the UE 115 to generate the RACH preamble 210 (e.g., if the indicated cyclic shift matches the nominal cyclic shift). The UE 115 may then reselect (e.g., randomly) a preamble sequence and, in some cases, a cyclic shift 225. The UE 115 may transmit a response message 220 (also referred to herein as a msgY) to the network entity 105-a that includes the re-selected preamble sequence in a dedicated resource (e.g., an RO) indicated by the collision resolution message. In this manner, the response messages 220 may be separable (e.g., may not collide) at the network entity 105-a. Specifically, each UE 115 may select a different preamble sequence to generate a respective response message 220 and may transmit the respective response message 220 in a different RO as indicated by the response message(s) 215. Thus, the response messages 220 may not include the same preamble sequence and may arrive at the network entity 105-a at different times (e.g., based on the corresponding ROs). Accordingly, the network entity 105-a may be able to identify which UE 115 transmitted each response message 220 and may be able to correctly detect the respective preamble sequences and cyclic shifts 225.

In some examples, the network entity 105-a may detect the collision between the RACH preambles 210 (e.g., transmitted from the UE 115-a and the UE 115-b) to trigger transmission of the response messages 215 (e.g., msgX), and subsequently the transmission of the response messages 220 (e.g., msgY) by the UEs 115. For example, the network entity 105-a may use an algorithm to determine if a collision has occurred (e.g., and to identify which preamble sequence and cyclic shift combination(s) with which the collision is associated). The network entity 105-a may provide one or more of a quantity of detected taps (e.g., in a root/cyclic shift or frequency domain), history information of an associated channel, and environment information associated with the cell 205 as inputs to the algorithm to determine if a collision has occurred. In some cases, the network entity 105-a may use multipath detection (e.g., in a time domain) to detect the collision between RACH preambles 210. Multipath detection may adequately detect collisions of RACH preambles 210 when the cell 205 is relatively large, in part because the arrival times of RACH preambles 210 at the network entity 105-a transmitted by UEs 115 located throughout the cell may differ (e.g., such that the RACH preambles 210 may be separable at the network entity 105-a) due to the UEs 115-a being geographically spaced out within the cell 205 (e.g., due to differing distances between each of the UEs 115 and the network entity 105-a).

In some cases, the network entity 105-a may assume that two or more RACH preambles 210 detected by the multipath detection and having the same cyclic shift originate from different UEs 115. In other cases, however, a single UE 115 may transmit a RACH preamble 210 via multipath signaling. The multipath detection of the network entity 105-a may flag such a multipath transmission as a collision (e.g., a false alarm). Such false alarms may lead to increased latency (e.g., delays), increased overhead (e.g., signaling overhead) for collision resolution, or both, in the wireless communications system 200. The network entity 105-a may accordingly select parameters for the multipath detection to establish a balance between false alarms and detecting collisions. Additionally, or alternatively, the network entity 105-a may assume there is a collision with each RACH preamble 210 (e.g., even if a single path is detected) and may trigger collision resolution for every received RACH preamble 210, which may result in increased latency and overhead.

In other examples, the network entity 105-a may not detect a collision. That is, the network entity 105-a may determine that a received RACH preamble 210 is from a single UE 115, or may be able to detect an originating UE 115 associated with each received RACH preamble 210. In such examples, the response message 215 may include or be an example of a RAR message (e.g., msg2) and the response message 220 may include or be an example of a msg3. Here, the response message 215 may indicate UE identifying information (e.g., a cyclic shift 225 and preamble sequence used by the corresponding UE 115 to transmit the RACH preamble 210) and resource information for the UE 115 to use to transmit the response message 220.

As discussed above, if the UE 115-a and the UE 115-b select a same root and a same cyclic shift 225 for a respective RACH preamble 210 and, after the propagation delay, the RACH preambles 210 have a same or similar arrival time at the network entity 105-a, a collision (e.g., a single tap collision) may occur. In such a collision, the RACH preambles 210 may not be distinguishable in a time domain (e.g., the collision may be a time domain collision). The likelihood of collisions between RACH preambles 210 at the network entity 105-a may be based on a quantity of cyclic shifts 225 in the set of cyclic shifts, a cyclic shift step size 245, a distribution of UEs 115 within the cell 205, a quantity of UEs 115 operating in the cell 205, or a combination thereof. For example, the arrival time of a RACH preamble 210 at the network entity 105-a may be based on a propagation delay 227 determined by the location of the transmitting UE 115 in the cell 205, the distance between the UE 115 and the network entity 105-a, or the like. If multiple UEs 115 have similar propagation delays 227, the likelihood of collisions between RACH preambles 210 transmitted by the UEs 115 may increase. Additionally, as the quantity of UEs 115 in the cell 205 increases, the likelihood that multiple UEs may select a same cyclic shift 225 for transmission of respective RACH preambles 210 may increase.

The likelihood of collisions between RACH preambles 210 may be illustrated by a detected cyclic shift distribution 230. A detected cyclic shift distribution 230 may be understood as a distribution in cyclic shifts 225 detected by the network entity 105-a in corresponding RACH preambles 210, and may be based on the propagation delay 227 of RACH preambles 210 within the cell 205 and the cyclic shifts 225 (e.g., the nominal cyclic shifts) selected for the RACH preambles 210. The arrival time of a RACH preamble 210 at the network entity 105-a may be a convolution 235 of the cyclic shift 225 selected by a corresponding UE 115 and a propagation delay 227 for the RACH preamble 210. A relatively wide detected cyclic shift distribution 230 may correspond to a relatively low likelihood of collisions between RACH preambles 210. In contrast, in a relatively small serving cell, the detected cyclic shift distribution 230 associated with the cell 205 may be relatively narrow, which may correspond to a relatively higher likelihood that RACH preambles 210 may collide.

As illustrated in FIG. 2, when detected cyclic shift distributions 230 (e.g., detected cyclic shift distributions 230-a, 230-b, and 230-c) are non-overlapping, the corresponding RACH preambles 210 may not collide at the network entity 105-a. Thus, the cyclic shifts 225 may be configured for the cell 205 to prevent detected cyclic shift distributions 230 from overlapping with one another, which may be achieved by optimizing the cyclic shift step size 245 for the set of cyclic shifts. The cyclic shifts 225 may be spaced apart from one another by the cyclic shift step size 245, where the cyclic shift step size 245 may be large enough that the network entity 105-a can determine which cyclic shift 225 has been applied to a RACH preamble 210. That is, the cyclic shift step size 245 should be of a sufficient size such that the network entity 105-a is able to unambiguously identify a nominal cyclic shift from a detected cyclic shift. The cyclic shift step size 245 may be based on a maximum radius (e.g., size, RTT) of the cell 205, a maximum propagation delay of transmissions within the cell 205, or both. In some cases, the cyclic shift step size 245 may be greater than a largest RTT associated with the cell 205 (e.g., an RTT associated with a UE 115 at the edge of the cell 205).

Although the UEs 115 may randomly select (e.g., based on the cyclic shift step size 245) cyclic shifts 225 for the respective RACH preambles 210, the detected cyclic shift distributions 230 at the network entity 105-a may not be uniformly distributed, e.g., based on the associated propagation delays 227. For example, in a case where the UEs 115 are uniformly distributed throughout the cell 205, the network entity 105-a may be subject to the detected cyclic shift distribution 230-d. The detected cyclic shift distribution 230-d may occur when a quantity of UEs 115 within a relatively small radius from the network entity 105-a is much less than a quantity of UEs 115 within a larger radius from the network entity 105-a (e.g., due to the uniform distribution of UEs 115 in the cell 205). In some cases, some or all of the UEs 115 within the cell 205 may be located at a same location (e.g., a hot spot) within the cell 205. In such a case, the network entity 105-a may be subject to the detected cyclic shift distribution 230-c, where some or all of the UEs 115 may experience a same or similar propagation delay 227.

In some other cases, the cyclic shift step size 245 associated with the cyclic shifts 225 may not be optimized for the cell 205. In such cases, the cyclic shift step size 245 of the cyclic shifts 225 for the UEs 115 in the cell 205 may be the cyclic shift step size 245-b, which is conservative (e.g., larger) compared to the cyclic shift step size 245-a. Here, the detected cyclic shift distribution 230-f may be shorter than the cyclic shift step size 245-b, which may correspond to an increased likelihood of collisions.

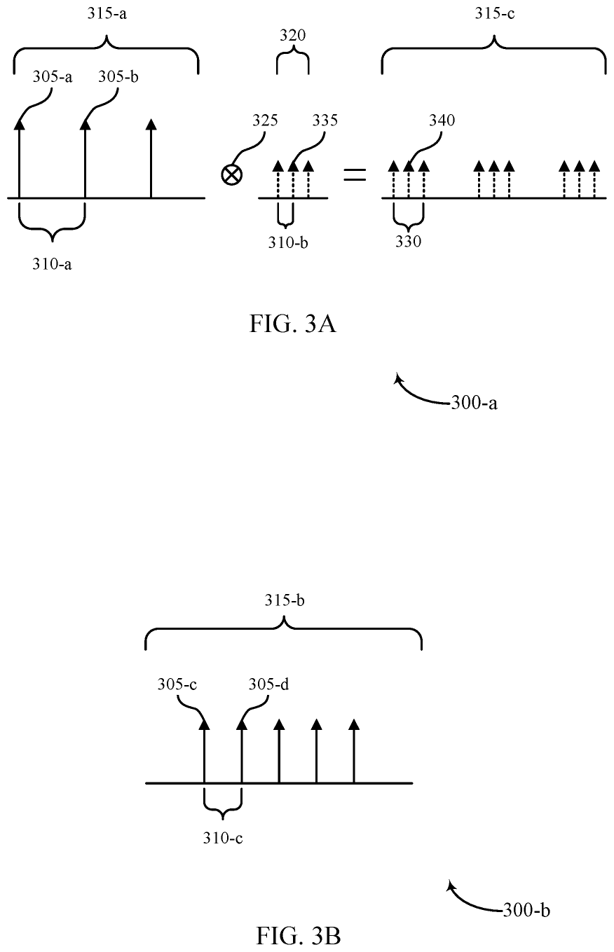

To reduce the likelihood of collisions occurring in the cell 205, each UE 115 may perform cyclic shift dithering. That is, each UE 115 may select a cyclic shift 225 (e.g., a nominal cyclic shift), and may further select (e.g., randomly select) a cyclic shift offset from a set of dithered (e.g., closely and regularly spaced) cyclic shift offsets (e.g., offset from the nominal cyclic shift). A “dithered” cyclic shift may be understood as a combination of a nominal cyclic shift and a cyclic shift offset. In some implementations, an offset step size between the dithered cyclic shifts may be less than the cyclic shift step size 245 between the nominal cyclic shifts (e.g., the offset step size may be less than the largest RTT of the cell). Such implementations are described in further detail with reference to FIG. 3.

Additionally, or alternatively, an implementation of the present disclosure may be to allow the UEs 115 to select a cyclic shift 225 from a set of cyclic shifts 225, where a cyclic shift step size 245 of the set of cyclic shifts 225 is less than the largest RTT of the cell 205. This implementation may effectively increase the quantity of cyclic shifts 225 available to the UEs 115 and may spread out the detected cyclic shift distribution 230 of the cell 205, which may decrease the chance of a collision between RACH preambles 210. In such an implementation, the cyclic shift offset may be selected as a zero offset. This implementation may effectively fit more cyclic shifts 225 in the same amount of cyclic shift resources. Such implementations are described in further detail with reference to FIG. 3.

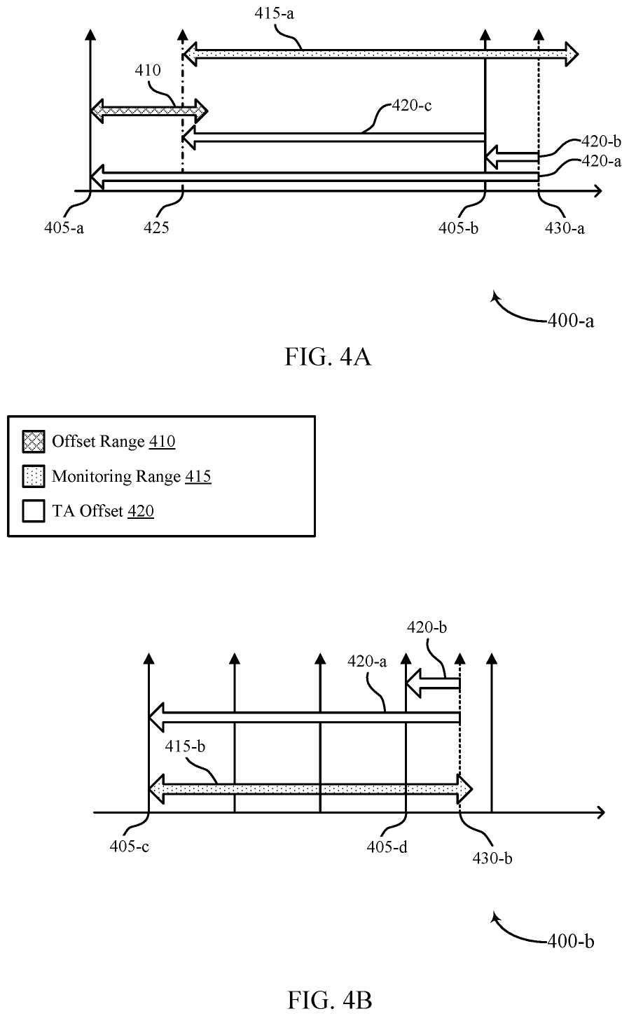

In some examples, cyclic shift dithering or decreased cyclic shift step sizes 245 may result in an overlap between detected cyclic shift distributions 230. In such examples, the network entity 105-a may be less likely to correctly identify a nominal cyclic shift based on a detected cyclic shift, as the detected cyclic shift may correspond to two or more nominal cyclic shifts. The network entity 105-a may therefore indicate an approximated cyclic shift in the first response message 215. Additionally, or alternatively, the network entity 105-a may indicate a detected cyclic shift in the response message 215 (e.g., rather than approximating a nominal cyclic shift). Such techniques are described in further detail with reference to FIG. 4.

FIGS. 3A and 3B show examples of a cyclic shift diagram 300-a and a cyclic shift diagram 300-b that support collision reduction for random access procedures in accordance with one or more aspects of the present disclosure. Aspects of the cyclic shift diagram 300-a and the cyclic shift diagram 300-b may implement or be implemented by aspects of the wireless communications system 100 and the wireless communications system 200. For example, the cyclic shift diagram 300-a and the cyclic shift diagram 300-b may be implemented by a UE 115 and a network entity 105, which may be examples of the corresponding devices as described with reference to FIG. 1.

A UE 115 may be configured with a set of cyclic shifts and a set of preamble sequences for use in RACH procedures as described herein. For instance, the UE 115 may receive a control message (e.g., an RRC message, a MAC-CE) indicating the set of cyclic shifts, the set of preamble sequences, or both. To increase a uniformity of a transmitted cyclic shift distribution and accordingly reduce a probability of a collision between RACH preambles (e.g., msg1s) at a network entity 105, the techniques described herein may support spreading (e.g., widening) the transmitted cyclic shift distribution. That is, if an arrival time distribution associated with the transmitted cyclic shift distribution is not uniform, widening the transmitted cyclic shift distribution may reduce the probability of collisions between RACH preambles. This may be achieved by combining cyclic shifts 305 (e.g., nominal cyclic shifts) with offsets 335 (e.g., dithering the cyclic shifts 305, as shown in FIG. 3A), or by decreasing a cyclic shift step size 310 between the cyclic shifts 305 (e.g., as shown in FIG. 3B).

FIG. 3A illustrates an example of cyclic shift dithering illustrated by the cyclic shift diagram 300-a. To generate a RACH preamble, the UE 115 may select a preamble sequence from a set of preamble sequences and a cyclic shift from a first set of cyclic shifts associated with a cyclic shift step size that is less than an RTT of a serving cell of the UE. The UE may generate the first set of cyclic shifts from nominal cyclic shifts 305 (e.g., a nominal cyclic shift 305-a, a nominal cyclic shift 305-b) from a set of nominal cyclic shifts 315-a and offsets 335 (e.g., cyclic shift offsets) from a set of offsets 320 (e.g., a set of cyclic shift offsets). In some examples, each nominal cyclic shift 305 may correspond to a respective set of offsets 320. By combining each nominal cyclic shift 305 with one or more offsets 335 of the set of offsets 320, the UE 115 may obtain the first set of cyclic shifts, which may be referred to herein as a set of dithered cyclic shifts 315-c. The UE may use a dithered cyclic shift 340 from the set of dithered cyclic shifts 315-c (e.g., together with the selected preamble sequence) to generate the RACH preamble. In one example, the UE 115 may perform a convolution 325 with the set of nominal cyclic shifts 315-a and the set of offsets 320 to generate the set of dithered cyclic shifts 315-c, and the UE 115 may select (e.g., randomly select) the dithered cyclic shift 340 from the set of dithered cyclic shifts 315-c.

The set of nominal cyclic shifts 315-a may be associated with a step size 310-a (e.g., a cyclic shift step size) between the nominal cyclic shifts 305. The step size 310-a may be defined as a spacing between adjacent cyclic shifts within the set of nominal cyclic shifts 315-a, such as between the nominal cyclic shift 305-a and the nominal cyclic shift 305-b. The step size 310-a may be, for example, greater than an RTT (e.g., a maximum RTT) of a serving cell associated with the network entity 105 and the UE 115. The set of offsets 320 may be distributed such that a spacing between offsets within the set of offsets 320 is less than a RTT (e.g., an RTT window length, the maximum RTT) of a serving cell associated with the network entity 105 and the UE 115. The spacing between offsets may be referred to as an offset step size 310-b. In some cases, the control message may indicate the set of nominal cyclic shifts 305, the set of offsets 320, or a combination thereof. Additionally, or alternatively, the control message may indicate the step size 310-a, the offset step size 310-b, or both.

The UE 115 may transmit the RACH preamble in accordance with the dithered cyclic shift 340, which may be different from other nominal cyclic shifts 305 selected by other UEs 115 (e.g., as compared to nominal cyclic shifts 305 which have not had an offset 335 applied). For example, a second UE 115 may select a different dithered cyclic shift from the set of dithered cyclic shifts 315-c (e.g., other than the dithered cyclic shift 340), and as such, the RACH preambles transmitted by the UE 115 and the second UE 115 may not collide at the network entity 105. In this way, if an arrival time of the RACH preamble from the UE 115 at the network entity 105 is the same as an arrival time of the RACH preamble from the second UE 115 (e.g., in the time domain), the offsets 335 (e.g., in the cyclic shift or frequency domain) may allow the network entity 105 to distinguish between the RACH preambles (e.g., in the time domain after performing a Fourier transform).

In some examples, the UE 115 may not perform dithering. That is, the UE 115 may select the nominal cyclic shift 305 and may use the nominal cyclic shift 305 without using the set of offsets 320. Additionally, or alternatively, the UE 115 may receive an indication of a set of offsets 320 comprising (e.g., only comprising) an offset of 0. In some cases, the UE 115 may determine whether to use a nominal cyclic shift 305 or a dithered cyclic shift 340 from the set of dithered cyclic shifts 315-c based on a configuration received from the network entity 105, e.g., indicated in the control message.

In some examples, the network entity 105 may not be aware of the dithering (e.g., the set of offsets 320 applied to the set of nominal cyclic shifts 315-a) performed by the UE 115. That is, the network entity 105 may be configured with the set of cyclic shifts 315-a, but may not be configured with the set of dithered cyclic shifts 315-c. When the network entity receives the RACH preamble, the network entity 105 may determine a detected cyclic shift (e.g., the nominal cyclic shift 305 plus an offset 335 from the set of offsets 320 plus a propagation delay associated with the RACH preamble). In some examples, the network entity 105 may determine an approximated nominal cyclic shift based on the detected cyclic shift, for instance, by determining which cyclic shift of the set of cyclic shifts 315-a is closest to the detected cyclic shift (e.g., in the cyclic shift domain).

The network entity 105 may indicate the approximated nominal cyclic shift or the detected cyclic shift to the UE 115 in a first response message (e.g., in a response to the RACH preamble, such as a msg2 or a msgX). The UE 115 may determine if the first response message is designated for the UE 115 based on the indicated cyclic shift. For instance, the UE 115 may monitor for first response messages from the network entity 105 by checking whether each received first response message includes an indication of a closest (e.g., a previous) nominal cyclic shift 305 to the dithered cyclic shift 340 used by the UE 115 (in this case, the nominal cyclic shift 305-a) and the preamble sequence used by the UE 115 to generate the RACH preamble. If a first response message includes an indication of a cyclic shift and preamble sequence that match those used by the UE 115, the UE 115 may determine that the first response message is for the UE 115, and the UE 115 may accordingly transmit a second response message (e.g., a msg3 or a msgY) to the network entity 105. A more detailed discussion of the detected cyclic shift and the approximated nominal cyclic shift can be found in the description of FIG. 4.

FIG. 3B illustrates another example of cyclic shift dithering illustrated by the cyclic shift diagram 300-b. Here, to reduce a probability of a collision between RACH preambles at a network entity 105, the UE 115 may select a nominal cyclic shift 305 (e.g., a nominal cyclic shift 305-c, a nominal cyclic shift 305-d) from a set of nominal cyclic shifts 315-b, where the set of nominal cyclic shifts 315-b has a step size 310-c (e.g., a cyclic shift step size, a consistent step size, a regular step size) that is smaller than an RTT (e.g., a maximum RTT) of the serving cell associated with the network entity 105 and the UE 115. That is, the set of nominal cyclic shifts 315-b may be a set of dithered cyclic shifts that are preconfigured and indicated to the UE 115 (e.g., instead of the cyclic shift dithering being performed at the UE 115).

The UE 115 may receive a control message indicating the set of nominal cyclic shifts 315-b, the associated step size 310-c, or both (e.g., from the network entity 105). The set of nominal cyclic shifts 315-b may have relatively more cyclic shifts 305 than the set of cyclic shifts 315-a, e.g., due to the step size 310-a being greater than or equal to the RTT and the step size 310-c being less than the RTT. The UE 115 may therefore be less likely to select a same cyclic shift 305 as another UE 115, which may decrease the probability of collisions between the RACH preambles. In some examples, the UE 115 may perform dithering on (e.g., may apply an offset to) the nominal cyclic shift 305 selected from the set of nominal cyclic shifts 315-b. In some cases, the offset selected for a nominal cyclic shift 305 of the set of cyclic shifts 315-b may be a zero offset.

The network entity 105 may use an RTT window (e.g., a preconfigured window that is based on a size of the serving cell associated with the network entity 105) to determine a nominal cyclic shift based on a detected cyclic shift. That is, the network entity 105 may determine an approximated nominal cyclic shift based on a cyclic shift 305 of the set of cyclic shifts 315 that is closest to the detected cyclic shift. The network entity 105 may indicate the approximated nominal cyclic shift to the UE 115 in the first response message. The UE 115 may determine if the first response message is designated for the UE 115 if the indication of the approximated nominal cyclic shift corresponds to the nominal cyclic shift 305 selected by the UE 115.

In some examples (e.g., due to an overlap between detected cyclic shift distributions as a result of the smaller step size 310-c or due to dithering), the approximated nominal cyclic shift may not be the nominal cyclic shift 305 selected by the UE 115 for the RACH preamble, but the first response message may still be intended for the UE 115. That is, the network entity 105 may incorrectly estimate or otherwise determine the approximated nominal cyclic shift based on the detected cyclic shift. To ensure reception of the first response message, the UE 115 may accordingly monitor for a range of cyclic shifts indicated by the first response message. Put another way, the UE 115 may monitor for a first response message which indicates an estimated nominal cyclic shift within a monitoring range (e.g., a window, an RTT window) of the selected nominal cyclic shift 305. If the UE 115 receives a first response message that indicates a nominal cyclic shift within the monitoring range, the UE 115 may determine that the first response message is intended for the UE 115, and the UE 115 may transmit a second response message (e.g., a msg3, a msgY) based on the first response message.

FIGS. 4A and 4B show examples of cyclic shift diagrams 400-a and 400-b, respectively, that support collision reduction for random access procedures in accordance with one or more aspects of the present disclosure. Aspects of the cyclic shift diagrams 400-a and 400-b may implement or may be implemented by aspects of the wireless communications system 100, the wireless communications system 200, and the cyclic shift diagram 300. For example, the cyclic shift diagrams 400-a and 400-b may be implemented by a UE 115 and a network entity 105, which may be examples of the corresponding devices as described with reference to FIG. 1. Although quantities of cyclic shifts 405, offset ranges 410, and monitoring ranges 415 are shown in FIG. 4, it is noted that the aspects and techniques of the present disclosure may include any quantity of cyclic shifts 405, offset ranges 410, monitoring ranges 415, or any combination thereof.

In some examples, a UE 115 may initiate a random access procedure by transmitting a first RACH message (e.g., msg1), such as a RACH preamble, to a network entity 105. In the example of FIG. 4A, the UE 115 may select (e.g., randomly select) a preamble sequence from a set of preamble sequences and a dithered cyclic shift, where the dithered cyclic shift is obtained (e.g., as described herein with reference to FIG. 3) via a combination of a cyclic shift 405 (e.g., a nominal cyclic shift, such as a cyclic shift 405-a) from a set of cyclic shifts for the RACH preamble and a cyclic shift offset 425 (e.g., an offset from the cyclic shift 405-a) within an offset range 410 (e.g., the width of the set of offsets 320 as described herein with reference to FIG. 3). The UE 115 may generate and transmit the RACH preamble according to the preamble sequence, the cyclic shift 405-a, and the cyclic shift offset 425. The offset range 410 may be associated with or correspond to a set of cyclic shift offsets from which the UE 115 selects the cyclic shift offset 425, as described with reference to FIG. 3. The offset range 410 may be less than an RTT associated with a serving cell of the UE 115 and the network entity 105. The UE 115 may select the dithered cyclic shift based on the cyclic shift 405-a and the cyclic shift offset 425 to reduce a likelihood of collisions between the RACH preamble and other RACH preambles transmitted by other UEs 115 in the serving cell of the network entity 105.

In the example of FIG. 4B, the UE may select a preamble sequence from a set of preamble sequences and a cyclic shift 405 (e.g., a nominal cyclic shift, such as a cyclic shift 405-c) from a set of cyclic shifts for the RACH preamble. As illustrated in FIG. 4B, the cyclic shift 405 may not be associated with a cyclic shift offset; instead, the set of cyclic shifts may be preconfigured with a step size that is less than the RTT associated with the serving cell. For instance, the UE may receive a control message indicating the set of cyclic shifts and, in some cases, the step size. The UE may generate the RACH preamble according to the preamble sequence and the cyclic shift 405-c.

In some examples, the RACH preamble may collide with a second RACH preamble (e.g., transmitted by a second UE 115) at the network entity 105. That is, the RACH preamble and the second RACH preamble may have a same root and a same cyclic shift 405, such that the network entity 105 detects a single RACH preamble (e.g., rather than both of the RACH preamble and the second RACH preamble). In such examples, the network entity 105 may transmit a first response message (e.g., a collision resolution message, such as a msgX) to each of the UE 115 and the second UE 115 indicating resources for second response messages (e.g., msgYs), as described with reference to FIG. 2.

Alternatively, when the RACH preamble does not collide with the second RACH preamble, the network entity 105 may detect a cyclic shift, such as a detected cyclic shift 430 (e.g., a detected cyclic shift 430-a, a detected cyclic shift 430-b), and a preamble sequence (e.g., a root) associated with the received RACH preamble. The network entity 105 may estimate a nominal cyclic shift based on the detected cyclic shift 430. For example, the estimated nominal cyclic shift may be the first cyclic shift occurring prior to the detected cyclic shift 430, such as the cyclic shift 405-b in the example of FIG. 4A or the cyclic shift 405-d in the example of FIG. 4B. The network entity 105 may transmit an indication of a cyclic shift to the UE 115, e.g., in a first response message (e.g., msg2, msgX). In some cases, the indicated cyclic shift may be the estimated nominal cyclic shift (e.g., the first response message may indicate the cyclic shift 405-b or the cyclic shift 405-d). In other cases, the indicated cyclic shift may be the detected cyclic shift 430 (e.g., the first response message may indicate the detected cyclic shift 430). Here, the first response message may include or be an example of a MAC-CE having a format associated with indicating detected cyclic shifts.

The network entity 105 may transmit the first response message to the UE 115 indicating the preamble sequence and the cyclic shift. The UE 115 may determine that the first response message is for the UE 115 based on the preamble sequence and cyclic shift indicated in the first response message. In some cases, to determine that the first response message is for the UE 115, the UE 115 may determine that the preamble sequence is the same as the preamble sequence selected by the UE 115 for the first RACH message transmitted by the UE 115. In some cases (e.g., when the indicated cyclic shift is a nominal cyclic shift), to determine that the first response message is for the UE 115, the UE 115 may determine that the indicated cyclic shift is the cyclic shift 405-a (e.g., the nominal cyclic shift) selected by the UE 115 for the RACH preamble transmitted by the UE 115. In some other cases (e.g., when the indicated cyclic shift is the detected cyclic shift 430), to determine that the first response message is for the UE 115, the UE 115 may determine that the indicated cyclic shift is spaced from the cyclic shift 405 selected by the UE 115 by less than a monitoring range 415 (e.g., the indicated cyclic shift is within the monitoring range).

For example, as illustrated in FIG. 4A, based on the cyclic shift offset 425, the network entity 105 may determine the estimated nominal cyclic shift as the cyclic shift 405-b, when the UE 115 selected the cyclic shift 405-a for the RACH preamble. That is, while transmitting a RACH preamble according to a cyclic shift and a cyclic shift offset may prevent collisions between RACH preambles, the cyclic shift offset may cause the network entity 105 to incorrectly estimate the nominal cyclic shift used for the RACH preamble. In the example of FIG. 4A, the offset 425 from the cyclic shift 405-a may fall close to the cyclic shift 405-b (e.g., the subsequent cyclic shift in the set of cyclic shifts) in the cyclic shift domain, such that the network entity 105 detects the detected cyclic shift 420-a as occurring after the cyclic shift 405-b. Then, the network entity 105 may determine the estimated nominal cyclic shift to be the cyclic shift 405-b. In the example of FIG. 4B, the smaller step size associated with the cyclic shifts 405 may cause the network entity 105 to detect the detected cyclic shift 430 as occurring after the cyclic shift 405-d, such that the network entity 105 determines the estimated nominal cyclic shift to be the cyclic shift 405-d.

To account for the possibility of the network entity 105 selecting the subsequent cyclic shift from the nominal cyclic shift selected by the UE 115, the UE 115 may monitor for a first response message that indicates any cyclic shift within a monitoring range 415. In some examples, the monitoring range 415 may extend from the cyclic shift 405 selected by the UE through one or more other cyclic shifts 405 subsequent to the cyclic shift selected by the UE. The UE 115 may monitor for a first response message indicating a cyclic shift 405 which falls within the monitoring range 415. In some examples, the UE 115 may receive a control message indicating a configuration for the monitoring range 415, such as a quantity of cyclic shifts within the monitoring range 415.

In some examples, the monitoring range 415 may be the same as or smaller than a step size of the cyclic shifts 405. In such examples, the UE 115 may monitor for a first response message indicating the cyclic shift 405 selected by the UE 115 for the RACH preamble. In some examples, and as discussed herein, the offset range 410 may be smaller than the step size of the cyclic shifts 405. In such examples, the UE 115 may monitor for a first response message indicating the cyclic shift 405 selected for the first RACH message, as well as any other cyclic shifts that fall within the monitoring range 415.

In some examples, the network entity 105 may indicate, in the first response message, the preamble sequence and the detected cyclic shift 430. That is, the network entity 105 may indicate the detected cyclic shift 430 rather than the estimated nominal cyclic shift 405. The detected cyclic shift 430 may be a sum of the nominal cyclic shift 405 selected by the UE 115 (e.g., the cyclic shift 405-a, the cyclic shift 405-c), the cyclic shift offset (e.g., the cyclic shift offset 425), and a propagation delay associated with the RACH preamble.

The UE 115 may determine that the first response message is for the UE 115 based on the monitoring range 415. That is, the UE 115 may be configured (e.g., by the network entity 105) with the monitoring range 415 based on (e.g., as a function of) a size of the cell associated with the network entity 105. That is, the monitoring range 415 may be associated with (e.g., be necessary because of) propagation delay between the UEs 115 and the network entity 105. In some cases, the monitoring range 415 may be associated with the edge of the cell (e.g., the monitoring range 415 may be based on a maximum propagation delay for the cell). Additionally, or alternatively, the UE 115 may determine the monitoring range 415 based on the propagation delay, the nominal cyclic shifts 405, the cyclic shift offset 425, or any combination thereof.

In some examples, the UE 115 may receive the first response message indicating the preamble sequence used by the UE 115 and a cyclic shift 405 which falls within the monitoring range 415. The UE 115 may accordingly determine that the first response message is for the UE 115 and may transmit a second response message (e.g., msgY) via one or more resources (e.g., ROs) indicated by the first response message.

In some examples, the RACH preamble from the UE 115 and the second RACH preamble from the second UE 115 may not collide at the network entity 105. In such examples, the network entity 105 may transmit a first response message (e.g., a RAR message, a msg2) to each of the UE 115 and the second UE 115 indicating resources for respective second response messages (e.g., msg3) to be transmitted by the UEs. That is, the first response message may include or be an example of a RAR message or a msg2, and the second response message may include or be an example of a msg3.

In such examples, the first response message may indicate a TA offset 420 for the UE 115 to use to transmit the second response message, where the TA offset 420 indicates a timing according to which the UE 115 is to transmit the second response message. In some cases, the network entity 105 may determine (e.g., calculate, compute) the TA offset 420 based on the detected cyclic shift 430. For instance, the network entity may determine the TA offset to be a TA offset 420-a between the cyclic shift 405 selected for the RACH preamble (e.g., the cyclic shift 405-a, the cyclic shift 405-c) and the detected cyclic shift 430. In other examples, the network entity 105 may determine the TA offset 420 to be a TA offset 420-b based on the estimated nominal cyclic shift (e.g., the cyclic shift 405-b, the cyclic shift 405-d), e.g., instead of the detected cyclic shift 430.

In some cases, if the UE 115 performs dithering, the UE may have to adjust the TA offset 420 indicated by the network entity 105 based on the dithering, e.g., in order to transmit the second response message with appropriate timing. That is, the network entity 105 may be unaware of the dithering (e.g., the application of an offset 425 or the reduced step size) applied by the UE 115, and thus the TA offset 420 may be based on a different cyclic shift 405 than the cyclic shift 405 selected by the UE 115 for the RACH preamble. For example, the network entity may indicate the TA offset 420-b to the UE 115 based on the detected cyclic shift 430 and the estimated nominal cyclic shift, e.g., the cyclic shift 405-b or the cyclic shift 405-d. However, the correct TA offset for the cyclic shift 405 selected by the UE, e.g., the cyclic shift 405-a or the cyclic shift 405-c, may be a TA offset 420-a. Thus, the UE may determine the correct TA offset for the cyclic shift 405 selected by the UE even if it differs from the TA offset indicated by the network entity.

Additionally, or alternatively, the UE 115 may determine an adjusted TA offset, such as a TA offset 420-c, based on the TA offset 420 indicated by the network entity 105 and the cyclic shift offset 425. For example, if the network entity 105 indicates the TA offset 420-a, the UE may subtract the cyclic shift offset 425 from the TA offset 420-a to determine the adjusted TA offset 420-c. The UE 115 may, additionally, or alternatively, determine if the TA offset 420 exceeds the cyclic shift offset 425, based on which the UE 115 may determine whether the first response message is for the UE 115. For example, if the TA offset 420 does not exceed the cyclic shift offset 425, the UE 115 may determine that the first response message is not for the UE 115.

In some examples, the TA offset 420 indicated by the network entity in the first response message may be based on whether the network entity correctly estimates the nominal cyclic shift. For example, if the estimated nominal cyclic shift determined by the network entity is the cyclic shift 405 selected by the UE 115 (e.g., the network entity 105 correctly estimated the nominal cyclic shift), the first response message may indicate the TA offset 420-a. If the estimated nominal cyclic shift is not the cyclic shift 405 selected by the UE for the RACH preamble (e.g., the network entity 105 incorrectly approximates the nominal cyclic shift), the first response message may indicate the TA offset 420-b. Accordingly, if the UE 115 detects a first response message indicating the cyclic shift 405 selected for the first RACH message, the UE 115 may calculate the adjusted TA offset 420 (e.g., the TA offset 420-c) using the TA offset 420-a, the cyclic shift offset 425, or both. If the UE 115 detects a first response message indicating a cyclic shift 405 not selected for the RACH preamble, the UE 115 may calculate the adjusted TA offset 420 (e.g., TA offset 420-c) using the TA offset 420-b, the cyclic shift offset 425, an offset between the cyclic shift selected for the first RACH message and the indicated cyclic shift 405 (e.g., the step size, one or more step sizes), or some combination thereof.

In some examples, the network entity 105 may transmit the first response message with a MAC-CE format different from a msg2 format, where the MAC-CE format provides for an indication of the detected cyclic shift 430 (e.g., rather than an estimated nominal cyclic shift). In such examples, the UE 115 may compare the detected cyclic shift 430 with the cyclic shift offset 425, and may determine a TA offset 420 based on a gap between the detected cyclic shift 430 and the cyclic shift offset 425 (e.g., if the gap is within the RTT window). That is, the UE 115 may determine a gap between the cyclic shift 405 selected for the RACH preamble and the detected cyclic shift 430, where the gap is adjusted for the cyclic shift offset 425 based on the detected cyclic shift 430.

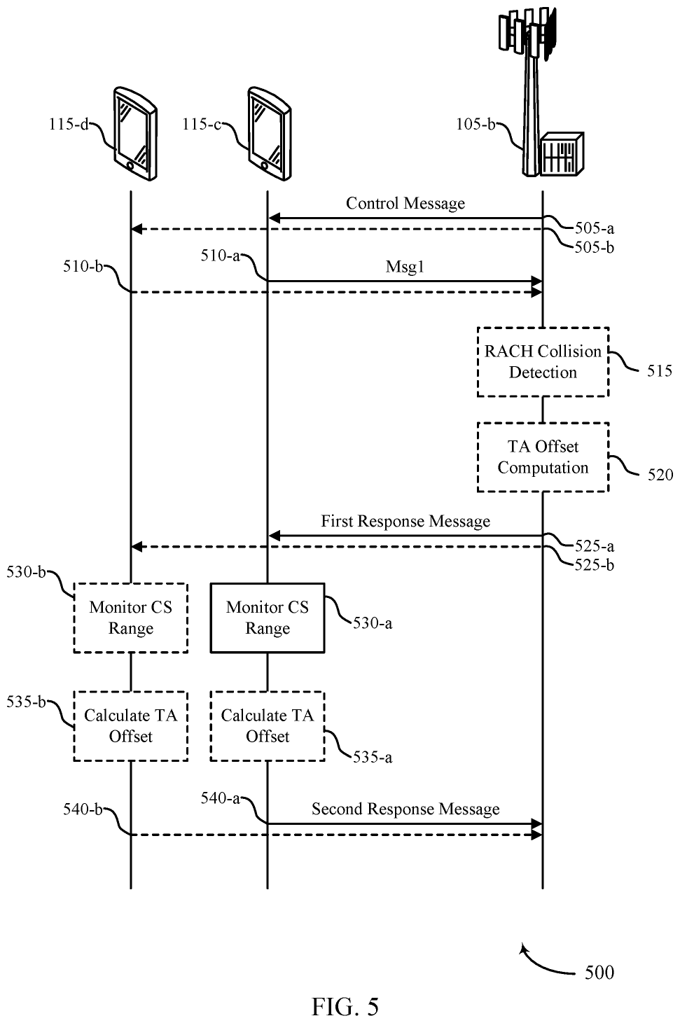

FIG. 5 shows an example of a process flow 500 that supports collision reduction for random access procedures in accordance with one or more aspects of the present disclosure. Aspects of the process flow 500 may implement or may be implemented by aspects of the wireless communications system 100, the wireless communications system 200, the cyclic shift diagram 300, and the cyclic shift diagram 400. For example, the process flow 500 may include one or more UEs 115 (e.g., a UE 115-c and a UE 115-d) and a network entity 105 (e.g., a network entity 105-b), which may be examples of the corresponding devices as described with reference to FIG. 1.

In the following description of the process flow 500, the operations between the network entity 105-b, the UE 115-c, and the UE 115-d may be transmitted in a different order than the example order shown. Some operations may also be omitted from the process flow 500, and other operations may be added to the process flow 500. Further, although some operations or signaling may be shown to occur at different times for discussion purposes, these operations may actually occur at the same time.

At 505-a, the network entity 105-b may transmit, and the UE 115-c may receive, a control message indicating a first set of cyclic shifts for transmission of a random access message (e.g., msg1) that includes a random access preamble. In some examples, the first set of cyclic shifts may have a cyclic shift step size that is greater than a largest (e.g., a maximum or threshold) RTT associated with a serving cell of the network entity 105-b. In other examples, the first set of cyclic shifts may have a cyclic shift step size that is less than the largest RTT associated with the serving cell of the network entity 105-b. In some examples, the control message may further indicate a cyclic shift monitoring range (e.g., in a cyclic shift domain) for the UE 115-c to monitor for a response message from the network entity 105-b. The cyclic shift monitoring range may be based on the RTT associated with the serving cell of the network entity 105-b.

In some cases, the control message may additionally or alternatively indicate a second set of cyclic shifts (e.g., with a cyclic shift step size that is larger than the RTT) and a set of cyclic shift offsets. In some cases, the set of cyclic shift offsets may have an offset spacing (e.g., an offset step size between each cyclic shift offset of the set of cyclic shift offsets) that is less than the RTT. In some cases, the UE 115-c may generate the first set of cyclic shifts based on the second set of cyclic shifts and the set of cyclic shift offsets. For example, the UE 115-c may perform a convolution of the second set of cyclic shifts and the set of cyclic shift offsets to obtain the first set of cyclic shifts.

Additionally, or alternatively, the control message may indicate the first set of cyclic shifts having a consistent (e.g., regular) cyclic shift spacing (e.g., cyclic shift step size between each cyclic shift of the set of cyclic shifts) that is less than the RTT. Stated differently, the cyclic shift spacing associated with the first set of cyclic shifts indicated by the control message may be a consistent spacing between each cyclic shift of the first set of cyclic shifts.

In some examples, at 505-b, the network entity 105-b may transmit, and the UE 115-d may receive, a second control message indicating the first set of cyclic shifts (e.g., and the cyclic shift monitoring range), the second set of cyclic shifts, the set of cyclic shift offsets, or some combination thereof. In some cases, the second control message may include similar information to (e.g., the same information as) the control message.

At 510-a, the UE 115-c may transmit, and the network entity 105-b may receive, the random access message including the random access preamble. The UE 115-c may transmit the first RACH message using a first cyclic shift of the first set of cyclic shifts, where the UE 115-c combines the set of cyclic shift offsets and the second set of cyclic shifts to obtain the first set of cyclic shifts, and then selects the first cyclic shift from the first set of cyclic shifts. The set of cyclic shift offsets may have a cyclic shift offset step size that is less than the largest (e.g., maximum) RTT associated with the serving cell of the network entity 105-b. In some examples (e.g., if the set of cyclic shifts has a cyclic shift step size that is smaller than the largest RTT associated with the serving cell), the cyclic shift offsets of the set of offsets may be equal to zero.

In some examples, at 510-b, the UE 115-d may transmit, and the network entity 105-b may receive, a second random access message (e.g., msg1) including a second random access preamble. The UE 115-b may transmit the ad second random access message using a second cyclic shift of the set of cyclic shifts with a second cyclic shift offset applied to the second cyclic shift. In some examples, the second cyclic shift and the second cyclic shift offset may be the same as the first cyclic shift and the first cyclic shift offset.

At 515, the network entity 105-b may perform a RACH collision detection procedure. For example, the network entity 105-b may determine if the random access message and the second random access message are separable in a cyclic shift domain by comparing the first cyclic shift and the second cyclic shift. In some examples (e.g., if the random access message and the second random access message are separable in the cyclic shift domain or are associated with different preamble sequences or different cyclic shifts), based on the comparison, the network entity 105-b may determine that there is not a collision. In some examples (e.g., if the random access message and the second random access message are received at a same time and are associated with a same preamble sequence or a same cyclic shift), based on the comparison, the network entity 105-b may determine that there is a collision. In some examples, the RACH collision detection procedure may be based on previous collision information associated with the serving cell, multipath information associated with the serving cell, or both.

In some examples, at 520, the network entity 105-b may perform a TA offset computation. The network entity 105-b may determine a third cyclic shift (e.g., a detected or nominal cyclic shift) associated with the random access message received from the UE 115-c. The third cyclic shift may be the first cyclic shift used by the UE 115-c. Alternatively, the third cyclic shift may be a different cyclic shift from the set of cyclic shifts. In some cases, the third cyclic shift may be a cyclic shift detected by the network entity 105-b (e.g., when receiving the random access message from the UE 115-c). The third cyclic shift may be based on a propagation delay between the UE 115-c and the network entity 105-b. The network entity 105-b may calculate or otherwise determine the TA offset using the third cyclic shift. The TA offset may be, for example, greater than or equal to the cyclic shift offset.

At 525-a, the network entity 105-b may transmit, and the UE 115-c may receive, a first response message. In some examples (e.g., if the network entity 105-b determined that there was not a collision), the first response message may be a RAR message (e.g., a second random access message, such as a msg2). In such examples, the first response message may indicate the TA offset and the third cyclic shift (e.g., and a preamble sequence associated with the random access message). In other examples (e.g., if the network entity 105-b determined that there was a collision), the response message may be a collision resolution message (e.g., msgX). In such examples, the collision resolution message may indicate the third cyclic shift (e.g., and the preamble sequence associated with the random access message) and one or more ROs for the UE 115-c to transmit a second response message.

In some examples, at 525-b, the network entity 105-b may transmit, and the UE 115-d may receive, a first response message (e.g., a msg2 or a collision resolution message such as a msgX) in response to the second random access message transmitted by the UE 115-d. The first response message may indicate one or more of a fourth cyclic shift, a TA offset, and a preamble sequence associated with the second random access message (e.g., as described with reference to steps 520 and 525-a). In some examples, one or both of the first response messages may be MAC-CE messages.

At 530-a, the UE 115-c may monitor for the first response message. The UE 115-c may determine that the response message is for the UE 115-c based on the first response message indicating a cyclic shift (e.g., the third cyclic shift) that falls within a cyclic shift monitoring range from the first cyclic shift (e.g., and indicating the preamble sequence associated with the random access message). In some examples, the cyclic shift monitoring range may be a same size as or greater than the step size associated with the set of cyclic shifts.

At 530-b, the UE 115-d may monitor for the first response message. The UE 115-d may determine that the response message is for the UE 115-d based on the first response message indicating a cyclic shift (e.g., the fourth cyclic shift) that falls within a cyclic shift monitoring range from the second cyclic shift (e.g., and indicating the preamble sequence associated with the second random access message).

At 535-a, in some examples (e.g., if the first response message is a RAR message), the UE 115-c may calculate a TA offset for a second response message (e.g., a msg3). For example, the UE 115-c may calculate the TA offset for the second response message using the TA offset indicated in the first response message at 525-a. The calculated TA offset may be calculated, for example, based on a difference between the first cyclic shift and the third cyclic shift. The calculated TA offset may be greater than or equal to the first cyclic shift offset.

At 535-b, in some examples (e.g., if the first response message is a RAR message), the UE 115-d may calculate a TA offset for a second response message (e.g., a msg3). For example, the UE 115-d may calculate the TA offset for the second response message using the TA offset indicated in the first response message at 525-b. The calculated TA offset may be calculated, for example, based on a difference between the second cyclic shift and the fourth cyclic shift. The calculated TA offset may be greater than or equal to the second cyclic shift offset.

At 540-a, the UE 115-c may transmit, to the network entity 105-b, a second response message. The UE 115-c may transmit the second response message using the indicated TA offset, the calculated TA offset, and one or more resources indicated in the first response message at 525-a. In some examples (e.g., if the first response message is a RAR message), the second message may be a third random access message (e.g., msg3). In other examples (e.g., if the first response message is a collision resolution message), the second response message may be a collision resolution response message (e.g., msgY). Here, the UE 115-c may transmit the collision resolution response message via an RO indicated by the first response message at 525-a.

At 540-b, the UE 115-d may transmit, to the network entity 105-b, a second response message. The UE 115-d may transmit the second response message using the indicated TA offset, the calculated TA offset, and one or more resources indicated in the first response message at 525-b. In some examples (e.g., if the first response message is a RAR message), the second message may be a third random access message (e.g., msg3). In other examples (e.g., if the first response message is a collision resolution message), the second response message may be a collision resolution response message (e.g., msgY). Here, the UE 115-d may transmit the collision resolution response message via an RO indicated by the first response message at 525-b.

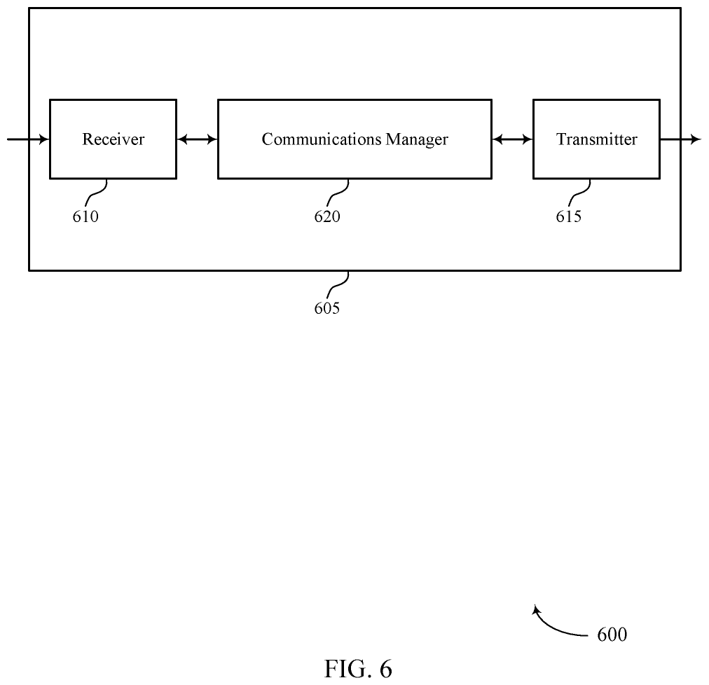

FIG. 6 shows a block diagram 600 of a device 605 that supports collision reduction for random access procedures in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to collision reduction for random access procedures). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to collision reduction for random access procedures). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of collision reduction for random access procedures as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 is capable of, configured to, or operable to support a means for receiving a control message indicating a first set of cyclic shifts for transmission of a random access message including a random access preamble. The communications manager 620 is capable of, configured to, or operable to support a means for transmitting the random access message in accordance with a cyclic shift of the first set of cyclic shifts, the first set of cyclic shifts being associated with a first cyclic shift step size that is less than a round trip time (RTT) associated with a serving cell of the UE.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources and reduced power consumption. For instance, by transmitting a random access preamble according to a cyclic shift and a cyclic shift offset, the device 605 may avoid collisions with other random access preambles transmitted by other devices. By avoiding such collisions, the device 605 may avoid using additional resources and power consumption for repeating a random access procedure.

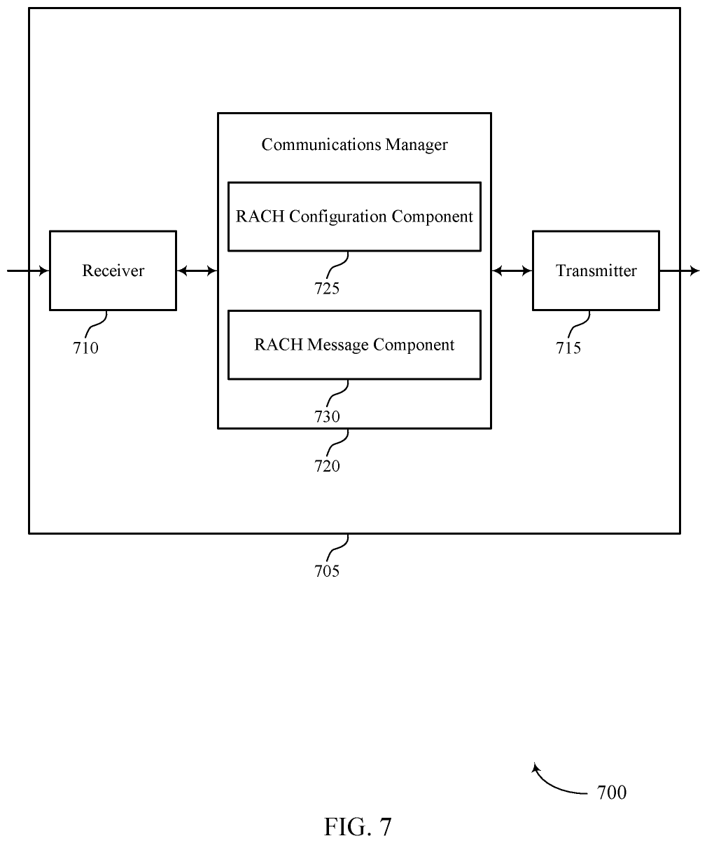

FIG. 7 shows a block diagram 700 of a device 705 that supports collision reduction for random access procedures in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to collision reduction for random access procedures). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to collision reduction for random access procedures). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of collision reduction for random access procedures as described herein. For example, the communications manager 720 may include a RACH configuration component 725 a RACH message component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The RACH configuration component 725 is capable of, configured to, or operable to support a means for receiving a control message indicating a first set of cyclic shifts for transmission of a random access message including a random access preamble. The RACH message component 730 is capable of, configured to, or operable to support a means for transmitting the random access message in accordance with a cyclic shift of the first set of cyclic shifts, the first set of cyclic shifts being associated with a first cyclic shift step size that is less than a round trip time (RTT) associated with a serving cell of the UE.

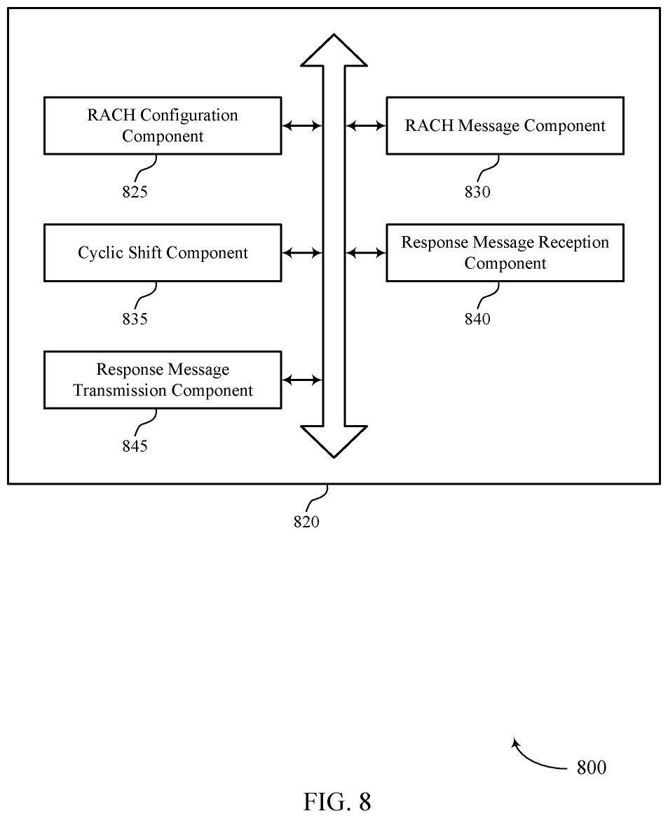

FIG. 8 shows a block diagram 800 of a communications manager 820 that supports collision reduction for random access procedures in accordance with one or more aspects of the present disclosure. The communications manager 820 may be an example of aspects of a communications manager 620, a communications manager 720, or both, as described herein. The communications manager 820, or various components thereof, may be an example of means for performing various aspects of collision reduction for random access procedures as described herein. For example, the communications manager 820 may include a RACH configuration component 825, a RACH message component 830, a cyclic shift component 835, a response message reception component 840, a response message transmission component 845, or any combination thereof. Each of these components, or components or subcomponents thereof (e.g., one or more processors, one or more memories), may communicate, directly or indirectly, with one another (e.g., via one or more buses).

The communications manager 820 may support wireless communication in accordance with examples as disclosed herein. The RACH configuration component 825 is capable of, configured to, or operable to support a means for receiving a control message indicating a first set of cyclic shifts for transmission of a random access message including a random access preamble. The RACH message component 830 is capable of, configured to, or operable to support a means for transmitting the random access message in accordance with a cyclic shift of the first set of cyclic shifts, the first set of cyclic shifts being associated with a first cyclic shift step size that is less than a round trip time (RTT) associated with a serving cell of the UE.

In some examples, to support receiving the control message indicating the first set of cyclic shifts, the RACH configuration component 825 is capable of, configured to, or operable to support a means for receiving the control message indicating a second set of cyclic shifts and a set of cyclic shift offsets including the cyclic shift offset, the set of cyclic shift offsets including the first cyclic shift step size. In some examples, to support receiving the control message indicating the first set of cyclic shifts, the RACH configuration component 825 is capable of, configured to, or operable to support a means for generating the first set of cyclic shifts based on the second set of cyclic shifts and the set of cyclic shift offsets.

In some examples, the cyclic shift component 835 is capable of, configured to, or operable to support a means for selecting the cyclic shift from the first set of cyclic shifts, the first set of cyclic shifts having a consistent cyclic shift step size that is less than the RTT.

In some examples, the control message indicates a cyclic shift monitoring range that is based on the RTT, and the response message reception component 840 is capable of, configured to, or operable to support a means for receiving a first response message indicating a root of the random access preamble and a second cyclic shift, where the first response message is for the UE based on the second cyclic shift being spaced from the cyclic shift by less than the cyclic shift monitoring range. In some examples, the control message indicates a cyclic shift monitoring range that is based on the RTT, and the response message transmission component 845 is capable of, configured to, or operable to support a means for transmitting a second response message based on the first response message.

In some examples, the first set of cyclic shifts is generated based on a second set of cyclic shifts and a set of cyclic shift offsets including the first cyclic shift step size. In some examples, the second cyclic shift is of the second set of cyclic shifts.

In some examples, to support receiving the first response message, the response message reception component 840 is capable of, configured to, or operable to support a means for receiving the second random access message indicating a timing advance offset for transmitting the second response message.

In some examples, to support transmitting the second response message, the response message transmission component 845 is capable of, configured to, or operable to support a means for transmitting the third random access message based on the timing advance offset and the cyclic shift offset, the timing advance offset being greater than or equal to the cyclic shift offset.

In some examples, the second cyclic shift is spaced from the cyclic shift based on a propagation delay between the UE and a network entity associated with the serving cell.

In some examples, to support transmitting the second response message, the response message transmission component 845 is capable of, configured to, or operable to support a means for transmitting the third random access message based on a timing advance offset, the timing advance offset corresponding to a difference between the second cyclic shift and the cyclic shift, where the third random access message is transmitted based on the difference being smaller than the cyclic shift monitoring range.

In some examples, to support transmitting the third random access message, the response message transmission component 845 is capable of, configured to, or operable to support a means for transmitting the third random access message based on the timing advance offset and the cyclic shift offset, the timing advance offset being greater than or equal to the cyclic shift offset.

In some examples, a size of the cyclic shift monitoring range is a same size as the first cyclic shift step size of the first set of cyclic shifts. In some examples, a size of the cyclic shift monitoring range is greater than or equal to the first cyclic shift step size of the first set of cyclic shifts.

In some examples, to support receiving the first response message, the response message reception component 840 is capable of, configured to, or operable to support a means for receiving the collision resolution message indicating one or more random access channel occasions for transmission of the second response message, where the second response message is transmitted via a random access channel occasion of the one or more random access channel occasions.

In some examples, the RTT corresponds to a threshold RTT supported by the serving cell.

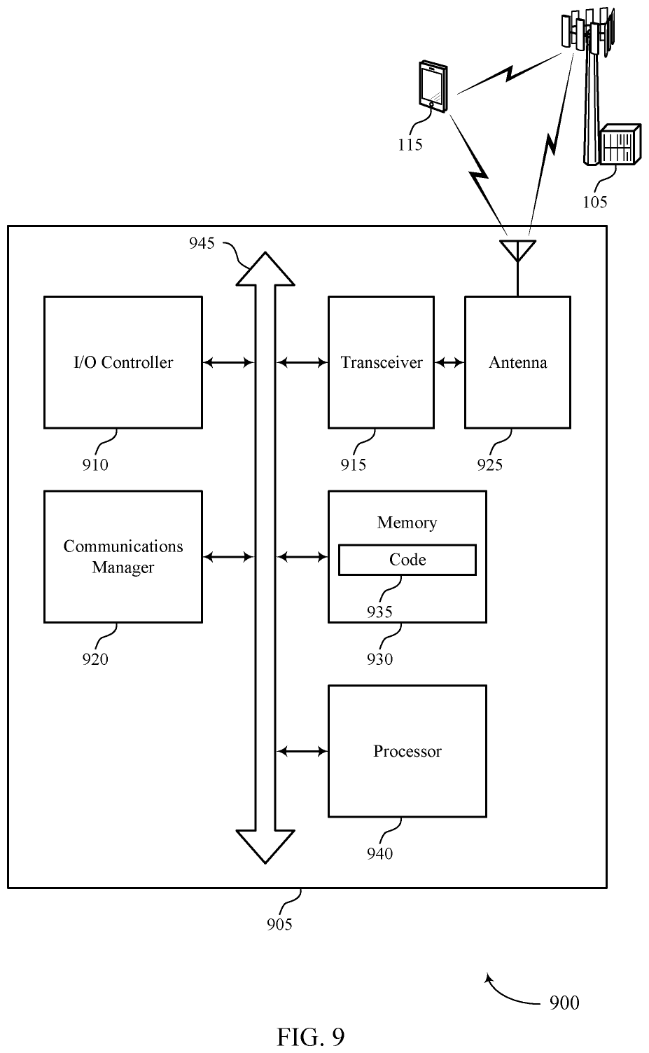

FIG. 9 shows a diagram of a system 900 including a device 905 that supports collision reduction for random access procedures in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting collision reduction for random access procedures). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. As such, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

The communications manager 920 may support wireless communication in accordance with examples as disclosed herein. For example, the communications manager 920 is capable of, configured to, or operable to support a means for receiving a control message indicating a first set of cyclic shifts for transmission of a random access message including a random access preamble. The communications manager 920 is capable of, configured to, or operable to support a means for transmitting the random access message in accordance with a cyclic shift of the first set of cyclic shifts, the first set of cyclic shifts being associated with a first cyclic shift step size that is less than a round trip time (RTT) associated with a serving cell of the UE.

By including or configuring the communications manager 920 in accordance with examples as described herein, the device 905 may support techniques for improved coordination between devices, more efficient utilization of communication resources, and reduced latency. For instance, by transmitting a random access preamble according to a cyclic shift and a cyclic shift offset, the device 905 may avoid collisions with other random access preambles transmitted by other devices. As such, the device 905 may increase the likelihood that a random access procedure associated with the random access preamble is successful. Additionally, by avoiding such collisions, the device 905 may avoid increased latency and wasted resources associated with a failed random access procedure.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of collision reduction for random access procedures as described herein, or the at least one processor 940 and the at least one memory 930 may be otherwise configured to, individually or collectively, perform or support such operations.

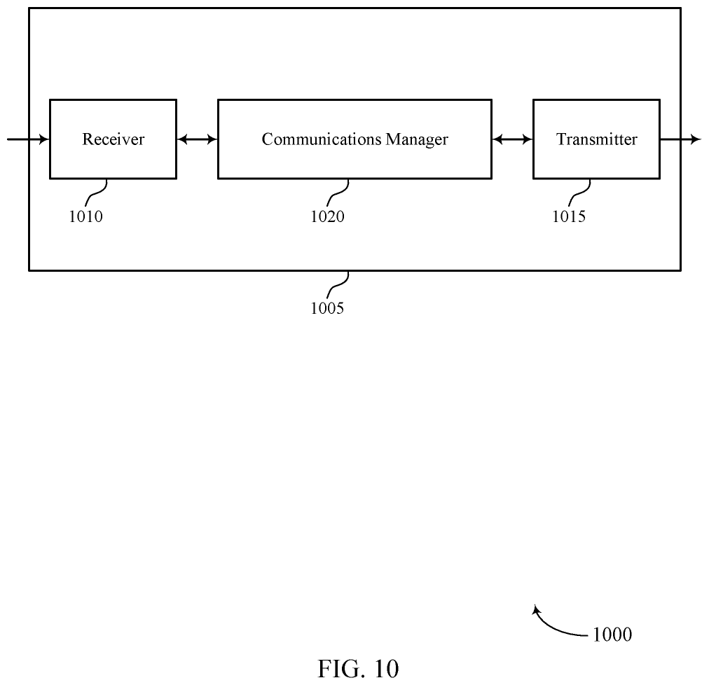

FIG. 10 shows a block diagram 1000 of a device 1005 that supports collision reduction for random access procedures in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of collision reduction for random access procedures as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. For example, the communications manager 1020 is capable of, configured to, or operable to support a means for transmitting, to a first UE and a second UE, a control message indicating a first set of cyclic shifts for transmission of one or more random access messages, the first set of cyclic shifts being associated with a first cyclic shift step size that is less than a round trip time (RTT) associated with a serving cell of the network entity. The communications manager 1020 is capable of, configured to, or operable to support a means for receiving a first random access message of the one or more random access messages from the first UE, the first random access message associated with a first cyclic shift based on the first set of cyclic shifts. The communications manager 1020 is capable of, configured to, or operable to support a means for receiving a second random access message of the one or more random access messages from the second UE, the second random access message associated with a second cyclic shift based on the first set of cyclic shifts. The communications manager 1020 is capable of, configured to, or operable to support a means for transmitting a response message for the first UE based on the control message, the first cyclic shift, and the second cyclic shift.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for more efficient utilization of communication resources and reduced latency. For instance, the device 1005 may be able to distinguish between random access preambles received from different devices or to detect that a collision between the random access preambles has occurred, which may improve the likelihood that a random access procedure with another device is successful and reduce latency associated with failed random access procedures. Additionally, the device 1005 may be able to resolve such collisions by transmitting collision resolution messages, which may improve resource utilization efficiency.

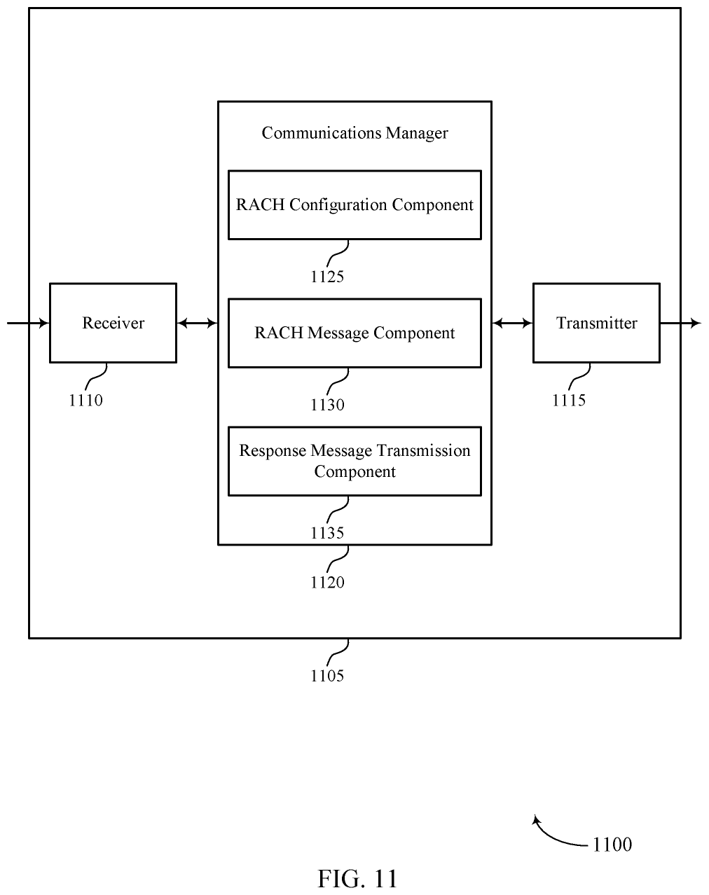

FIG. 11 shows a block diagram 1100 of a device 1105 that supports collision reduction for random access procedures in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of collision reduction for random access procedures as described herein. For example, the communications manager 1120 may include a RACH configuration component 1125, a RACH message component 1130, a response message transmission component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. The RACH configuration component 1125 is capable of, configured to, or operable to support a means for transmitting, to a first UE and a second UE, a control message indicating a first set of cyclic shifts for transmission of one or more random access messages, the first set of cyclic shifts being associated with a first cyclic shift step size that is less than a round trip time (RTT) associated with a serving cell of the network entity. The RACH message component 1130 is capable of, configured to, or operable to support a means for receiving a first random access message of the one or more random access messages from the first UE, the first random access message associated with a first cyclic shift based on the first set of cyclic shifts. The RACH message component 1130 is capable of, configured to, or operable to support a means for receiving a second random access message of the one or more random access messages from the second UE, the second random access message associated with a second cyclic shift based on the first set of cyclic shifts. The response message transmission component 1135 is capable of, configured to, or operable to support a means for transmitting a response message for the first UE based on the control message, the first cyclic shift, and the second cyclic shift.

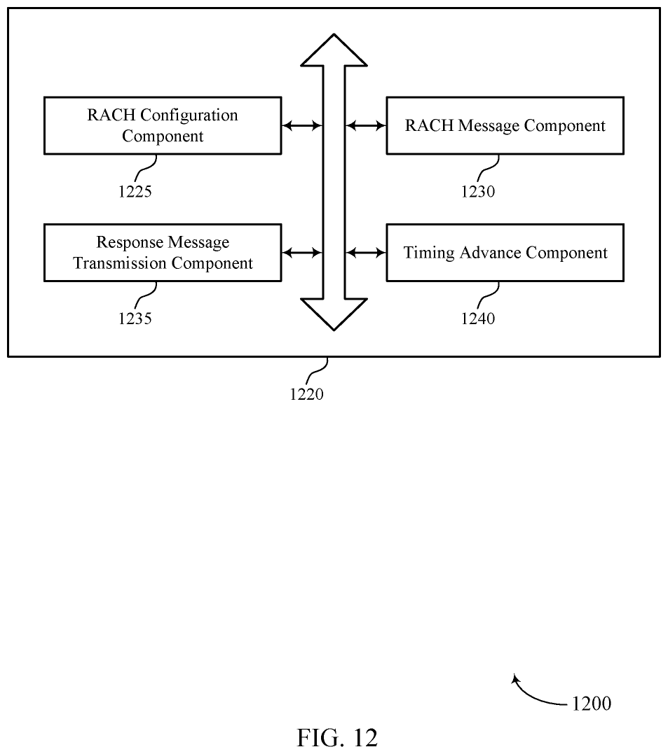

FIG. 12 shows a block diagram 1200 of a communications manager 1220 that supports collision reduction for random access procedures in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of collision reduction for random access procedures as described herein. For example, the communications manager 1220 may include a RACH configuration component 1225, a RACH message component 1230, a response message transmission component 1235, a timing advance component 1240, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication in accordance with examples as disclosed herein. The RACH configuration component 1225 is capable of, configured to, or operable to support a means for transmitting, to a first UE and a second UE, a control message indicating a first set of cyclic shifts for transmission of one or more random access messages, the first set of cyclic shifts being associated with a first cyclic shift step size that is less than a round trip time (RTT) associated with a serving cell of the network entity. The RACH message component 1230 is capable of, configured to, or operable to support a means for receiving a first random access message of the one or more random access messages from the first UE, the first random access message associated with a first cyclic shift based on the first set of cyclic shifts. In some examples, the RACH message component 1230 is capable of, configured to, or operable to support a means for receiving a second random access message of the one or more random access messages from the second UE, the second random access message associated with a second cyclic shift based on the first set of cyclic shifts. The response message transmission component 1235 is capable of, configured to, or operable to support a means for transmitting a response message for the first UE based on the control message, the first cyclic shift, and the second cyclic shift.

In some examples, to support transmitting the response message, the response message transmission component 1235 is capable of, configured to, or operable to support a means for determining that the first random access message and the second random access message are separable in a cyclic shift domain. In some examples, to support transmitting the response message, the response message transmission component 1235 is capable of, configured to, or operable to support a means for transmitting the random access response message including a timing advance offset and an indication of a third cyclic shift based on the first cyclic shift.

In some examples, to support transmitting the control message, the RACH configuration component 1225 is capable of, configured to, or operable to support a means for transmitting the control message indicating a cyclic shift monitoring range, the random access response message being for the first UE based on the third cyclic shift being within the cyclic shift monitoring range from the first cyclic shift.

In some examples, the first set of cyclic shifts is generated based on a second set of cyclic shifts and a set of cyclic shift offsets including the first cyclic shift step size. In some examples, the third cyclic shift is of the second set of cyclic shifts.

In some examples, the timing advance component 1240 is capable of, configured to, or operable to support a means for computing the timing advance offset based on the third cyclic shift. In some examples, the third cyclic shift is the same as the first cyclic shift.

In some examples, the random access response message includes a (MAC-CE.

In some examples, to support transmitting the response message, the response message transmission component 1235 is capable of, configured to, or operable to support a means for determining that the first cyclic shift is the same as the second cyclic shift and that the first random access message was received at a same time as the second random access message. In some examples, to support transmitting the response message, the response message transmission component 1235 is capable of, configured to, or operable to support a means for transmitting the collision resolution message for the first UE based on the control message and the determining, the collision resolution message including an indication of a third cyclic shift that is based on the first cyclic shift.

In some examples, the first set of cyclic shifts is generated based on a second set of cyclic shifts and a set of cyclic shift offsets including the first cyclic shift step size. In some examples, the third cyclic shift is of the second set of cyclic shifts.

In some examples, the third cyclic shift is the same as the first cyclic shift.

In some examples, to support transmitting the collision resolution message, the response message transmission component 1235 is capable of, configured to, or operable to support a means for transmitting the collision resolution message indicating one or more random access channel occasions for the first UE to transmit a second response message.

In some examples, to support transmitting the control message, the RACH configuration component 1225 is capable of, configured to, or operable to support a means for transmitting the control message indicating a cyclic shift monitoring range, the response message being for the first UE based on the third cyclic shift and the monitoring range.

In some examples, to support transmitting the response message, the response message transmission component 1235 is capable of, configured to, or operable to support a means for transmitting the response message based on a comparison between the first random access message and the second random access message based on previous collision information associated with the serving cell, multipath information associated with the serving cell, or a combination thereof.

In some examples, the RTT is a maximum RTT of the serving cell.

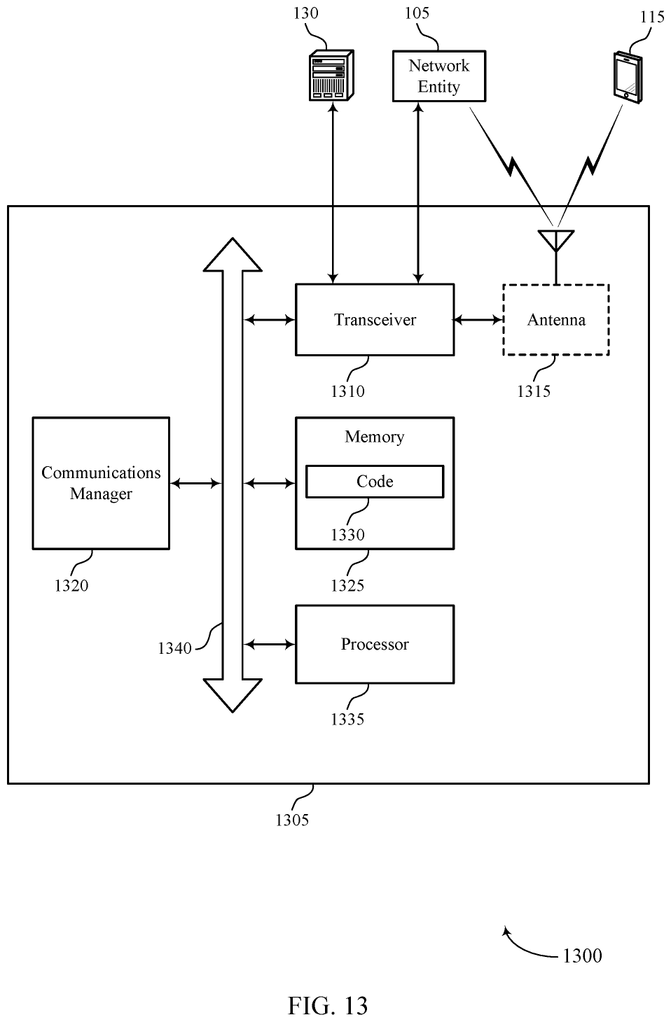

FIG. 13 shows a diagram of a system 1300 including a device 1305 that supports collision reduction for random access procedures in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting collision reduction for random access procedures). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. As such, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication in accordance with examples as disclosed herein. For example, the communications manager 1320 is capable of, configured to, or operable to support a means for transmitting, to a first UE and a second UE, a control message indicating a first set of cyclic shifts for transmission of one or more random access messages, the first set of cyclic shifts being associated with a first cyclic shift step size that is less than a round trip time (RTT) associated with a serving cell of the network entity. The communications manager 1320 is capable of, configured to, or operable to support a means for receiving a first random access message of the one or more random access messages from the first UE, the first random access message associated with a first cyclic shift based on the first set of cyclic shifts. The communications manager 1320 is capable of, configured to, or operable to support a means for receiving a second random access message of the one or more random access messages from the second UE, the second random access message associated with a second cyclic shift based on the first set of cyclic shifts. The communications manager 1320 is capable of, configured to, or operable to support a means for transmitting a response message for the first UE based on the control message, the first cyclic shift, and the second cyclic shift.

By including or configuring the communications manager 1320 in accordance with examples as described herein, the device 1305 may support techniques for improved coordination between devices, more efficient utilization of communication resources, and reduced latency. For instance, the device 1305 may be able to distinguish between random access preambles received from different devices or to detect that a collision between the random access preambles has occurred, which may improve the likelihood that a random access procedure with another device is successful and reduce latency associated with failed random access procedures. Additionally, the device 1305 may be able to resolve such collisions by transmitting collision resolution messages, which may improve resource utilization efficiency.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of collision reduction for random access procedures as described herein, or the at least one processor 1335 and the at least one memory 1325 may be otherwise configured to, individually or collectively, perform or support such operations.

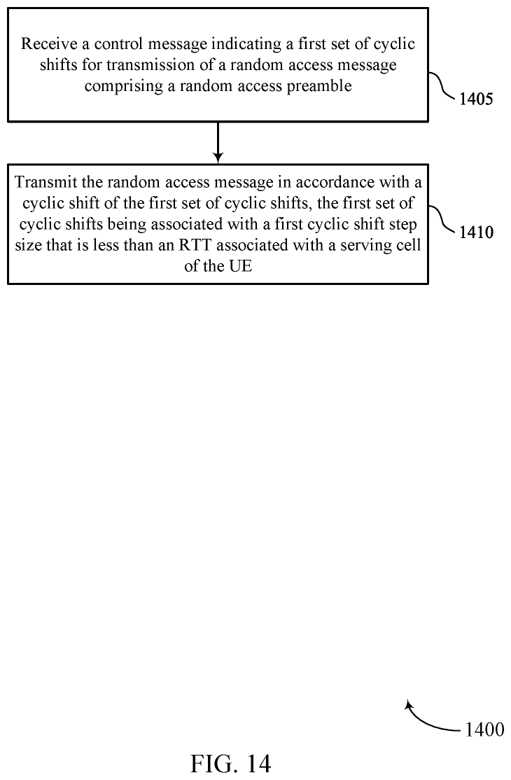

FIG. 14 shows a flowchart illustrating a method 1400 that supports collision reduction for random access procedures in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a control message indicating a first set of cyclic shifts for transmission of a random access message comprising a random access preamble. The operations of block 1405 may be performed in accordance with examples as disclosed herein. In some examples, aspects of the operations of 1405 may be performed by a RACH configuration component 825 as described with reference to FIG. 8.

At 1410, the method may include transmitting the random access message in accordance with a cyclic shift of the first set of cyclic shifts, the first set of cyclic shifts being associated with a first cyclic shift step size that is less than an RTT associated with a serving cell of the UE. The operations of block 1410 may be performed in accordance with examples as disclosed herein. In some examples, aspects of the operations of 1410 may be performed by a RACH message component 825 as described with reference to FIG. 8.

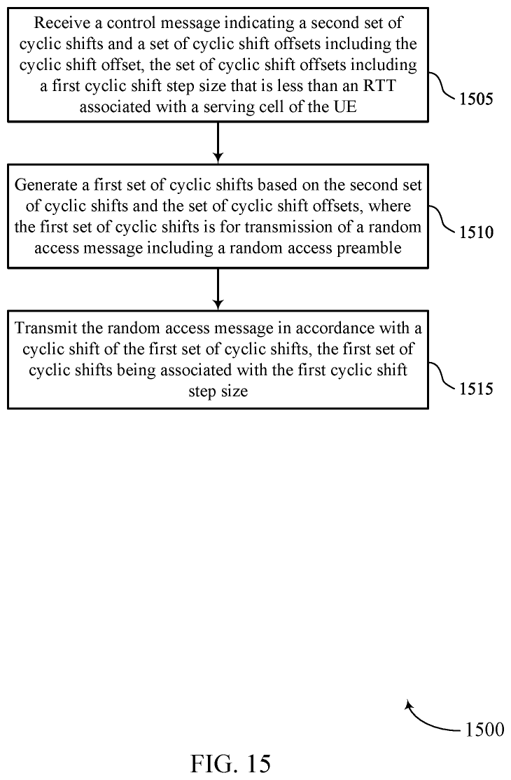

FIG. 15 shows a flowchart illustrating a method 1500 that supports collision reduction for random access procedures in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving a control message indicating a second set of cyclic shifts and a set of cyclic shift offsets including the cyclic shift offset, the set of cyclic shift offsets including a first cyclic shift step size that is less than an RTT associated with a serving cell of the UE. The operations of block 1505 may be performed in accordance with examples as disclosed herein. In some examples, aspects of the operations of 1505 may be performed by a RACH configuration component 825 as described with reference to FIG. 8.

At 1510, the method may include generating a first set of cyclic shifts based on the second set of cyclic shifts and the set of cyclic shift offsets, where the first set of cyclic shifts is for transmission of a random access message including a random access preamble. The operations of block 1510 may be performed in accordance with examples as disclosed herein. In some examples, aspects of the operations of 1510 may be performed by a RACH configuration component 825 as described with reference to FIG. 8.

At 1515, the method may include transmitting the random access message in accordance with a cyclic shift of the first set of cyclic shifts, the first set of cyclic shifts being associated with the first cyclic shift step size. The operations of block 1515 may be performed in accordance with examples as disclosed herein. In some examples, aspects of the operations of 1515 may be performed by a RACH message component 825 as described with reference to FIG. 8.

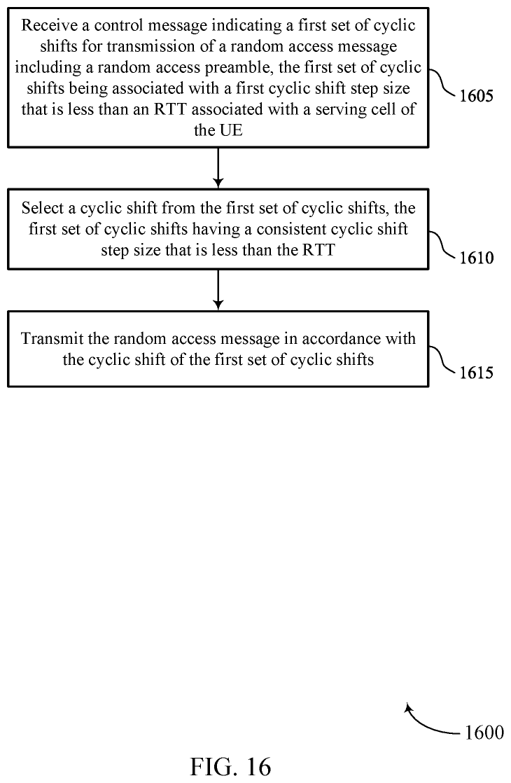

FIG. 16 shows a flowchart illustrating a method 1600 that supports collision reduction for random access procedures in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving a control message indicating a first set of cyclic shifts for transmission of a random access message including a random access preamble, the first set of cyclic shifts being associated with a first cyclic shift step size that is less than an RTT associated with a serving cell of the UE. The operations of block 1605 may be performed in accordance with examples as disclosed herein. In some examples, aspects of the operations of 1605 may be performed by a RACH configuration component 825 as described with reference to FIG. 8.

At 1610, the method may include selecting the cyclic shift from the first set of cyclic shifts, the first set of cyclic shifts having a consistent cyclic shift step size that is less than the RTT. The operations of block 1610 may be performed in accordance with examples as disclosed herein. In some examples, aspects of the operations of 1610 may be performed by a cyclic shift component 835 as described with reference to FIG. 8.

At 1615, the method may include transmitting the random access message in accordance with the cyclic shift of the first set of cyclic shifts. The operations of block 1615 may be performed in accordance with examples as disclosed herein. In some examples, aspects of the operations of 1615 may be performed by a RACH message component 830 as described with reference to FIG. 8.

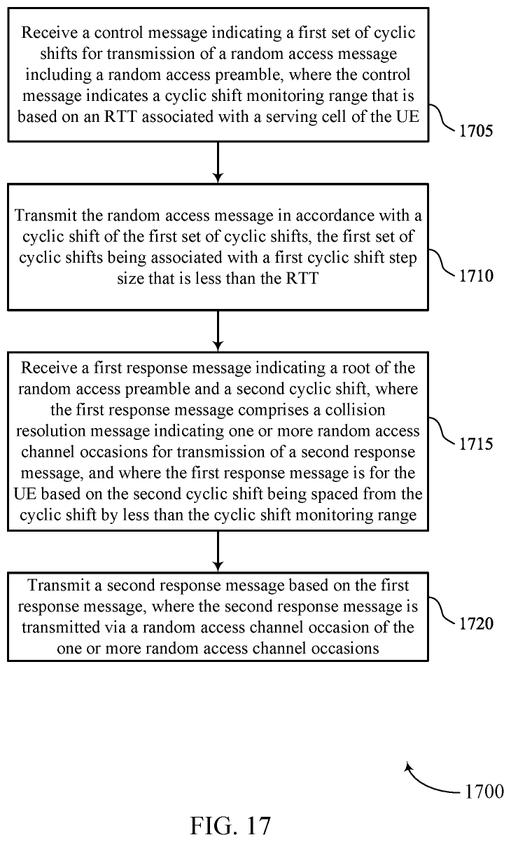

FIG. 17 shows a flowchart illustrating a method 1700 that supports collision reduction for random access procedures in accordance with aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include receiving a control message indicating a first set of cyclic shifts for transmission of a random access message including a random access preamble, where the control message indicates a cyclic shift monitoring range that is based on an RTT associated with a serving cell of the UE. The operations of block 1705 may be performed in accordance with examples as disclosed herein. In some examples, aspects of the operations of 1705 may be performed by a RACH configuration component 825 as described with reference to FIG. 8.

At 1710, the method may include transmitting the random access message in accordance with a cyclic shift of the first set of cyclic shifts, the first set of cyclic shifts being associated with a first cyclic shift step size that is less than the RTT. The operations of block 1710 may be performed in accordance with examples as disclosed herein. In some examples, aspects of the operations of 1710 may be performed by a RACH message component 830 as described with reference to FIG. 8.

At 1715, the method may include receiving a first response message indicating a root of the random access preamble and a second cyclic shift, where the first response message comprises a collision resolution message indicating one or more random access channel occasions for transmission of a second response message, and where the first response message is for the UE based on the second cyclic shift being spaced from the cyclic shift by less than the cyclic shift monitoring range. The operations of block 1715 may be performed in accordance with examples as disclosed herein. In some examples, aspects of the operations of 1715 may be performed by a response message reception component 840 as described with reference to FIG. 8.

At 1720, the method may include transmitting a second response message based on the first response message, where the second response message is transmitted via a random access channel occasion of the one or more random access channel occasions. The operations of block 1720 may be performed in accordance with examples as disclosed herein. In some examples, aspects of the operations of 1720 may be performed by a response message transmission component 840 as described with reference to FIG. 8.

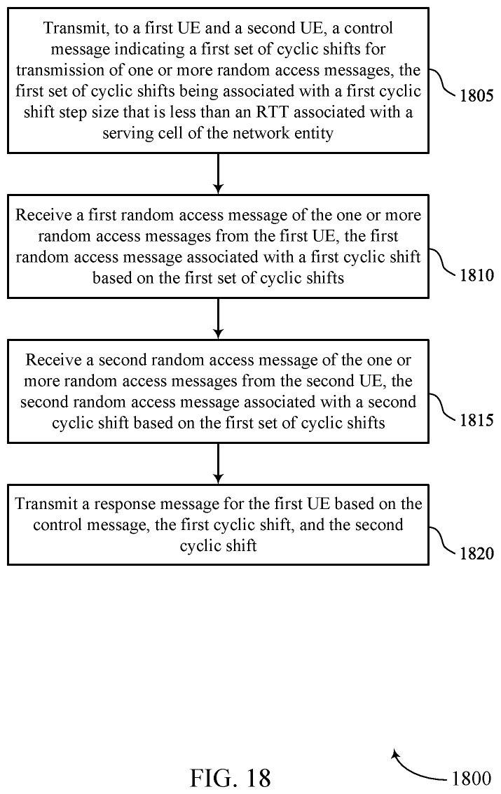

FIG. 18 shows a flowchart illustrating a method 1800 that supports collision reduction for random access procedures in accordance with aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, to a first UE and a second UE, a control message indicating a first set of cyclic shifts for transmission of one or more random access messages, the first set of cyclic shifts being associated with a first cyclic shift step size that is less than an RTT associated with a serving cell of the network entity. The operations of block 1805 may be performed in accordance with examples as disclosed herein. In some examples, aspects of the operations of 1805 may be performed by a RACH configuration component 1225 as described with reference to FIG. 12.

At 1810, the method may include receiving a first random access message of the one or more random access messages from the first UE, the first random access message associated with a first cyclic shift based on the first set of cyclic shifts. The operations of block 1810 may be performed in accordance with examples as disclosed herein. In some examples, aspects of the operations of 1810 may be performed by a RACH message component 1230 as described with reference to FIG. 12.

At 1815, the method may include receiving a second random access message of the one or more random access messages from the second UE, the second random access message associated with a second cyclic shift based on the first set of cyclic shifts. The operations of block 1815 may be performed in accordance with examples as disclosed herein. In some examples, aspects of the operations of 1815 may be performed by a RACH message component 1230 as described with reference to FIG. 12.

At 1820, the method may include transmitting a response message for the first UE based on the control message, the first cyclic shift, and the second cyclic shift. The operations of block 1820 may be performed in accordance with examples as disclosed herein. In some examples, aspects of the operations of 1820 may be performed by a response message transmission component 1235 as described with reference to FIG. 12.

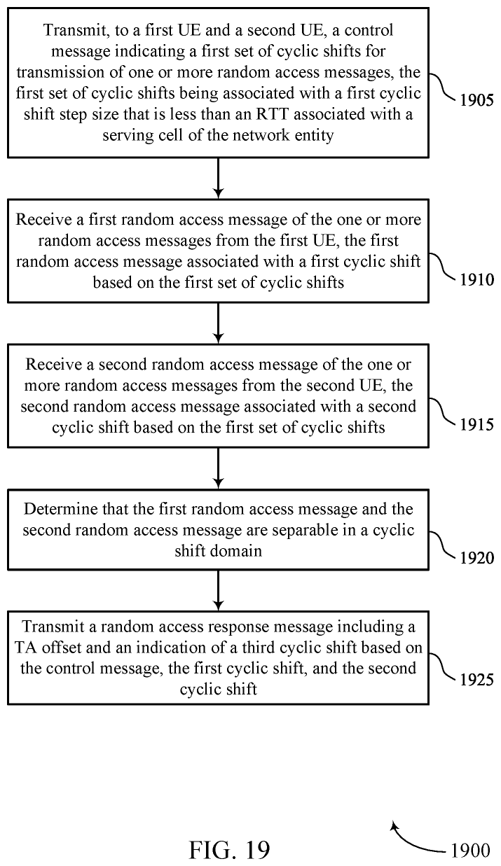

FIG. 19 shows a flowchart illustrating a method 1900 that supports collision reduction for random access procedures in accordance with aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include transmitting a second response message based on the first response message, where the second response message is transmitted via a random access channel occasion of the one or more random access channel occasions. The operations of block 1905 may be performed in accordance with examples as disclosed herein. In some examples, aspects of the operations of 1905 may be performed by a RACH configuration component 1225 as described with reference to FIG. 12.

At 1910, the method may include receiving a first random access message of the one or more random access messages from the first UE, the first random access message associated with a first cyclic shift based on the first set of cyclic shifts. The operations of block 1910 may be performed in accordance with examples as disclosed herein. In some examples, aspects of the operations of 1910 may be performed by a RACH message component 1230 as described with reference to FIG. 12.

At 1915, the method may include receiving a second random access message of the one or more random access messages from the second UE, the second random access message associated with a second cyclic shift based on the first set of cyclic shifts. The operations of block 1915 may be performed in accordance with examples as disclosed herein. In some examples, aspects of the operations of 1915 may be performed by a RACH message component 1230 as described with reference to FIG. 12.

At 1920, the method may include determining that the first random access message and the second random access message are separable in a cyclic shift domain. The operations of block 1920 may be performed in accordance with examples as disclosed herein. In some examples, aspects of the operations of 1920 may be performed by a response message transmission component 1235 as described with reference to FIG. 12.

At 1925, the method may include transmitting a random access response message including a TA offset and an indication of a third cyclic shift based on the control message, the first cyclic shift, and the second cyclic shift. The operations of block 1925 may be performed in accordance with examples as disclosed herein. In some examples, aspects of the operations of 1925 may be performed by a response message transmission component 1235 as described with reference to FIG. 12.

The following provides an overview of aspects of the present disclosure:

Aspect 1: A method for wireless communication at a UE, comprising: receiving a control message indicating a first set of cyclic shifts for transmission of a random access message comprising a random access preamble; and transmitting the random access message in accordance with a cyclic shift of the first set of cyclic shifts, the first set of cyclic shifts being associated with a first cyclic shift step size that is less than a round trip time (RTT) associated with a serving cell of the UE.

Aspect 2: The method of aspect 1, wherein the cyclic shift is based at least in part on a cyclic shift offset that is less than the RTT, and wherein receiving the control message indicating the first set of cyclic shifts comprises: receiving the control message indicating a second set of cyclic shifts and a set of cyclic shift offsets comprising the cyclic shift offset, the set of cyclic shift offsets comprising the first cyclic shift step size; and generating the first set of cyclic shifts based at least in part on the second set of cyclic shifts and the set of cyclic shift offsets.

Aspect 3: The method of any of aspects 1 through 2, further comprising: selecting the cyclic shift from the first set of cyclic shifts, the first set of cyclic shifts having a consistent cyclic shift step size that is less than the RTT.

Aspect 4: The method of any of aspects 1 through 3, wherein the control message indicates a cyclic shift monitoring range that is based at least in part on the RTT, the method further comprising: receiving a first response message indicating a root of the random access preamble and a second cyclic shift, wherein the first response message is for the UE based at least in part on the second cyclic shift being spaced from the cyclic shift by less than the cyclic shift monitoring range; and transmitting a second response message based at least in part on the first response message.

Aspect 5: The method of aspect 4, wherein the first set of cyclic shifts is generated based at least in part on a second set of cyclic shifts and a set of cyclic shift offsets comprising the first cyclic shift step size, and the second cyclic shift is of the second set of cyclic shifts.

Aspect 6: The method of aspect 5, wherein the first response message comprises a second random access message, and wherein receiving the first response message comprises: receiving the second random access message indicating a timing advance offset for transmitting the second response message.

Aspect 7: The method of aspect 6, wherein the cyclic shift is based at least in part on a cyclic shift offset that is less than the RTT, wherein the second response message comprises a third random access message, and wherein transmitting the second response message comprises: transmitting the third random access message based at least in part on the timing advance offset and the cyclic shift offset, the timing advance offset being greater than or equal to the cyclic shift offset.

Aspect 8: The method of any of aspects 4 through 7, wherein the second cyclic shift is spaced from the cyclic shift based at least in part on a propagation delay between the UE and a network entity associated with the serving cell.

Aspect 9: The method of aspect 8, wherein the second response message comprises a third random access message, and wherein transmitting the second response message comprises: transmitting the third random access message based at least in part on a timing advance offset, the timing advance offset corresponding to a difference between the second cyclic shift and the cyclic shift, wherein the third random access message is transmitted based at least in part on the difference being smaller than the cyclic shift monitoring range.

Aspect 10: The method of aspect 9, wherein the cyclic shift is based at least in part on a cyclic shift offset that is less than the RTT, and wherein transmitting the third random access message comprises: transmitting the third random access message based at least in part on the timing advance offset and the cyclic shift offset, the timing advance offset being greater than or equal to the cyclic shift offset.

Aspect 11: The method of any of aspects 4 through 10, wherein a size of the cyclic shift monitoring range is a same size as the first cyclic shift step size of the first set of cyclic shifts.

Aspect 12: The method of any of aspects 4 through 10, wherein a size of the cyclic shift monitoring range is greater than or equal to the first cyclic shift step size of the first set of cyclic shifts.

Aspect 13: The method of any of aspects 4 through 5, wherein the first response message comprises a collision resolution message, and wherein receiving the first response message comprises: receiving the collision resolution message indicating one or more random access channel occasions for transmission of the second response message, wherein the second response message is transmitted via a random access channel occasion of the one or more random access channel occasions.

Aspect 14: The method of any of aspects 1 through 13, wherein the RTT corresponds to a threshold RTT supported by the serving cell.

Aspect 15: A method for wireless communication at a network entity, comprising: transmitting, to a first UE and a second UE, a control message indicating a first set of cyclic shifts for transmission of one or more random access messages, the first set of cyclic shifts being associated with a first cyclic shift step size that is less than a round trip time (RTT) associated with a serving cell of the network entity; receiving a first random access message of the one or more random access messages from the first UE, the first random access message associated with a first cyclic shift based at least in part on the first set of cyclic shifts; receiving a second random access message of the one or more random access messages from the second UE, the second random access message associated with a second cyclic shift based at least in part on the first set of cyclic shifts; and transmitting a response message for the first UE based at least in part on the control message, the first cyclic shift, and the second cyclic shift.

Aspect 16: The method of aspect 15, wherein the response message comprises a random access response message, and wherein transmitting the response message comprises: determining that the first random access message and the second random access message are separable in a cyclic shift domain; and transmitting the random access response message comprising a timing advance offset and an indication of a third cyclic shift based at least in part on the first cyclic shift.

Aspect 17: The method of aspect 16, wherein transmitting the control message comprises: transmitting the control message indicating a cyclic shift monitoring range, the random access response message being for the first UE based at least in part on the third cyclic shift being within the cyclic shift monitoring range from the first cyclic shift.

Aspect 18: The method of any of aspects 16 through 17, wherein the first set of cyclic shifts is generated based at least in part on a second set of cyclic shifts and a set of cyclic shift offsets comprising the first cyclic shift step size, and the third cyclic shift is of the second set of cyclic shifts.

Aspect 19: The method of aspect 18, further comprising: computing the timing advance offset based at least in part on the third cyclic shift.

Aspect 20: The method of any of aspects 16 through 19, wherein the third cyclic shift is the same as the first cyclic shift.

Aspect 21: The method of aspect 20, wherein the random access response message comprises a medium access control control element (MAC-CE).

Aspect 22: The method of aspect 15, wherein the response message comprises a collision resolution message, and wherein transmitting the response message comprises: determining that the first cyclic shift is the same as the second cyclic shift and that the first random access message was received at a same time as the second random access message; and transmitting the collision resolution message for the first UE based at least in part on the control message and the determining, the collision resolution message comprising an indication of a third cyclic shift that is based at least in part on the first cyclic shift.

Aspect 23: The method of aspect 22, wherein the first set of cyclic shifts is generated based at least in part on a second set of cyclic shifts and a set of cyclic shift offsets comprising the first cyclic shift step size, and the third cyclic shift is of the second set of cyclic shifts.

Aspect 24: The method of any of aspects 22 through 23, wherein the third cyclic shift is the same as the first cyclic shift.

Aspect 25: The method of any of aspects 22 through 24, wherein transmitting the collision resolution message comprises: transmitting the collision resolution message indicating one or more random access channel occasions for the first UE to transmit a second response message.

Aspect 26: The method of any of aspects 22 through 25, wherein transmitting the control message comprises: transmitting the control message indicating a cyclic shift monitoring range, the response message being for the first UE based at least in part on the third cyclic shift and the monitoring range.

Aspect 27: The method of any of aspects 15 through 26, wherein transmitting the response message comprises: transmitting the response message based on a comparison between the first random access message and the second random access message based at least in part on previous collision information associated with the serving cell, multipath information associated with the serving cell, or a combination thereof.

Aspect 28: The method of any of aspects 15 through 27, wherein the RTT is a maximum RTT of the serving cell.

Aspect 29: A UE for wireless communication, comprising one or more memories storing processor-executable code, and one or more processors coupled with the one or more memories and individually or collectively operable to execute the code to cause the UE to perform a method of any of aspects 1 through 14.

Aspect 30: A UE for wireless communication, comprising at least one means for performing a method of any of aspects 1 through 14.

Aspect 31: A non-transitory computer-readable medium storing code for wireless communication, the code comprising instructions executable by a processor to perform a method of any of aspects 1 through 14.

Aspect 32: A network entity for wireless communication, comprising one or more memories storing processor-executable code, and one or more processors coupled with the one or more memories and individually or collectively operable to execute the code to cause the network entity to perform a method of any of aspects 15 through 28.

Aspect 33: A network entity for wireless communication, comprising at least one means for performing a method of any of aspects 15 through 28.

Aspect 34: A non-transitory computer-readable medium storing code for wireless communication, the code comprising instructions executable by a processor to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a control message indicating a first set of cyclic shifts for transmission of a random access message comprising a random access preamble; and
transmit the random access message in accordance with a cyclic shift of the first set of cyclic shifts, the first set of cyclic shifts being associated with a first cyclic shift step size that is less than a round trip time (RTT) associated with a serving cell of the UE.

2. The UE of claim 1, wherein the cyclic shift is based at least in part on a cyclic shift offset that is less than the RTT, and wherein, to receive the control message indicating the first set of cyclic shifts, the one or more processors are individually or collectively operable to execute the code to cause the UE to:
receive the control message indicating a second set of cyclic shifts and a set of cyclic shift offsets comprising the cyclic shift offset, the set of cyclic shift offsets comprising the first cyclic shift step size; and
generate the first set of cyclic shifts based at least in part on the second set of cyclic shifts and the set of cyclic shift offsets.

3. The UE of claim 1, wherein the one or more processors are individually or collectively further operable to execute the code to cause the UE to:
select the cyclic shift from the first set of cyclic shifts, the first set of cyclic shifts having a consistent cyclic shift step size that is less than the RTT.

4. The UE of claim 1, wherein the control message indicates a cyclic shift monitoring range that is based at least in part on the RTT, and the one or more processors are individually or collectively further operable to execute the code to cause the UE to:
receive a first response message indicating a root of the random access preamble and a second cyclic shift, wherein the first response message is for the UE based at least in part on the second cyclic shift being spaced from the cyclic shift by less than the cyclic shift monitoring range; and
transmit a second response message based at least in part on the first response message.

5. The UE of claim 4, wherein the first set of cyclic shifts is generated based at least in part on a second set of cyclic shifts and a set of cyclic shift offsets comprising the first cyclic shift step size, and the second cyclic shift is of the second set of cyclic shifts.

6. The UE of claim 5, wherein the first response message comprises a second random access message, and wherein, to receive the first response message, the one or more processors are individually or collectively operable to execute the code to cause the UE to:
receive the second random access message indicating a timing advance offset for transmitting the second response message.

7. The UE of claim 6, wherein the cyclic shift is based at least in part on a cyclic shift offset that is less than the RTT, wherein the second response message comprises a third random access message, and wherein, to transmit the second response message, the one or more processors are individually or collectively operable to execute the code to cause the UE to:
transmit the third random access message based at least in part on the timing advance offset and the cyclic shift offset, the timing advance offset being greater than or equal to the cyclic shift offset.

8. The UE of claim 4, wherein the second cyclic shift is spaced from the cyclic shift based at least in part on a propagation delay between the UE and a network entity associated with the serving cell.

9. The UE of claim 8, wherein the second response message comprises a third random access message, and wherein, to transmit the second response message, the one or more processors are individually or collectively operable to execute the code to cause the UE to:
transmit the third random access message based at least in part on a timing advance offset, the timing advance offset corresponding to a difference between the second cyclic shift and the cyclic shift, wherein the third random access message is transmitted based at least in part on the difference being smaller than the cyclic shift monitoring range.

10. The UE of claim 9, wherein the cyclic shift is based at least in part on a cyclic shift offset that is less than the RTT, and wherein, to transmit the third random access message, the one or more processors are individually or collectively operable to execute the code to cause the UE to:
transmit the third random access message based at least in part on the timing advance offset and the cyclic shift offset, the timing advance offset being greater than or equal to the cyclic shift offset.

11. The UE of claim 4, wherein a size of the cyclic shift monitoring range is a same size as the first cyclic shift step size of the first set of cyclic shifts.

12. The UE of claim 4, wherein a size of the cyclic shift monitoring range is greater than or equal to the first cyclic shift step size of the first set of cyclic shifts.

13. The UE of claim 4, wherein the first response message comprises a collision resolution message, and wherein, to receive the first response message, the one or more processors are individually or collectively operable to execute the code to cause the UE to:
receive the collision resolution message indicating one or more random access channel occasions for transmission of the second response message, wherein the second response message is transmitted via a random access channel occasion of the one or more random access channel occasions.

14. The UE of claim 1, wherein the RTT corresponds to a threshold RTT supported by the serving cell.

15. A network entity, comprising:
one or more memories storing processor-executable code; and
one or more processors coupled with the one or more memories and individually or collectively operable to execute the code to cause the network entity to:
transmit, to a first user equipment (UE) and a second UE, a control message indicating a first set of cyclic shifts for transmission of one or more random access messages, the first set of cyclic shifts being associated with a first cyclic shift step size that is less than a round trip time (RTT) associated with a serving cell of the network entity;
receive a first random access message of the one or more random access messages from the first UE, the first random access message associated with a first cyclic shift based at least in part on the first set of cyclic shifts;
receive a second random access message of the one or more random access messages from the second UE, the second random access message associated with a second cyclic shift based at least in part on the first set of cyclic shifts; and
transmit a response message for the first UE based at least in part on the control message, the first cyclic shift, and the second cyclic shift.

16. The network entity of claim 15, wherein the response message comprises a random access response message, and wherein, to transmit the response message, the one or more processors are individually or collectively operable to execute the code to cause the network entity to:
determine that the first random access message and the second random access message are separable in a cyclic shift domain; and
transmit the random access response message comprising a timing advance offset and an indication of a third cyclic shift based at least in part on the first cyclic shift.

17. The network entity of claim 16, wherein, to transmit the control message, the one or more processors are individually or collectively operable to execute the code to cause the network entity to:
transmit the control message indicating a cyclic shift monitoring range, the random access response message being for the first UE based at least in part on the third cyclic shift being within the cyclic shift monitoring range from the first cyclic shift.

18. The network entity of claim 16, wherein the first set of cyclic shifts is generated based at least in part on a second set of cyclic shifts and a set of cyclic shift offsets comprising the first cyclic shift step size, and the third cyclic shift is of the second set of cyclic shifts.

19. The network entity of claim 18, wherein the one or more processors are individually or collectively further operable to execute the code to cause the network entity to:
compute the timing advance offset based at least in part on the third cyclic shift.

20. The network entity of claim 16, wherein the third cyclic shift is the same as the first cyclic shift.

21. The network entity of claim 20, wherein the random access response message comprises a medium access control control element (MAC-CE).

22. The network entity of claim 15, wherein the response message comprises a collision resolution message, and wherein, to transmit the response message, the one or more processors are individually or collectively operable to execute the code to cause the network entity to:
determine that the first cyclic shift is the same as the second cyclic shift and that the first random access message was received at a same time as the second random access message; and
transmit the collision resolution message for the first UE based at least in part on the control message and the determining, the collision resolution message comprising an indication of a third cyclic shift that is based at least in part on the first cyclic shift.

23. The network entity of claim 22, wherein the first set of cyclic shifts is generated based at least in part on a second set of cyclic shifts and a set of cyclic shift offsets comprising the first cyclic shift step size, and the third cyclic shift is of the second set of cyclic shifts.

24. The network entity of claim 22, wherein the third cyclic shift is the same as the first cyclic shift.

25. The network entity of claim 22, wherein, to transmit the collision resolution message, the one or more processors are individually or collectively operable to execute the code to cause the network entity to:
transmit the collision resolution message indicating one or more random access channel occasions for the first UE to transmit a second response message.

26. The network entity of claim 22, wherein, to transmit the control message, the one or more processors are individually or collectively operable to execute the code to cause the network entity to:
transmit the control message indicating a cyclic shift monitoring range, the response message being for the first UE based at least in part on the third cyclic shift and the monitoring range.

27. The network entity of claim 15, wherein, to transmit the response message, the one or more processors are individually or collectively operable to execute the code to cause the network entity to:
transmit the response message based on a comparison between the first random access message and the second random access message based at least in part on previous collision information associated with the serving cell, multipath information associated with the serving cell, or a combination thereof.

28. The network entity of claim 15, wherein the RTT is a maximum RTT of the serving cell.

29. A method for wireless communication at a user equipment (UE), comprising:
receiving a control message indicating a first set of cyclic shifts for transmission of a random access message comprising a random access preamble; and
transmitting the random access message in accordance with a cyclic shift of the first set of cyclic shifts, the first set of cyclic shifts being associated with a first cyclic shift step size that is less than a round trip time (RTT) associated with a serving cell of the UE.

30. A method for wireless communication at a network entity, comprising:
transmitting, to a first user equipment (UE) and a second UE, a control message indicating a first set of cyclic shifts for transmission of one or more random access messages, the first set of cyclic shifts being associated with a first cyclic shift step size that is less than a round trip time (RTT) associated with a serving cell of the network entity;
receiving a first random access message of the one or more random access messages from the first UE, the first random access message associated with a first cyclic shift based at least in part on the first set of cyclic shifts;
receiving a second random access message of the one or more random access messages from the second UE, the second random access message associated with a second cyclic shift based at least in part on the first set of cyclic shifts; and
transmitting a response message for the first UE based at least in part on the control message, the first cyclic shift, and the second cyclic shift.
